(19) United States
(12) Patent Application Publication
(10) Pub. No.: US 2026/0222094 A1
(43) Pub. Date: Jul. 30, 2026

(54) RESOLVING NETWORK WEAK SPOTS ACCORDING TO USER EQUIPMENT (UE) DATA

(71) Applicant: QUALCOMM Incorporated, San Diego, CA (US)

(72) Inventors: Gal IZHAKI, Haifa (IL); German David CASTANEDA, Bogotá (CO)

(21) Appl. No.: 19/452,094

(22) Filed: Jan. 16, 2026

Related U.S. Application Data
(60) Provisional application No. 63/750,753, filed on Jan. 28, 2025.

(51) Int. Cl. H04B 17/391; H04B 17/318; H04L 41/16; H04W 74/0833

(52) U.S. Cl. CPC H04B 17/3912; H04B 17/328; H04L 41/16; H04W 74/0833

(57) ABSTRACT

A service, or platform, supporting data management and analytics may collect data associated with user equipment (UEs) operating within a wireless network. The data may indicate a geographic area of the wireless network that does not meet a signal threshold value. This geographic area may be referred to as a network weak spot. The service may select one or more updates to antenna configuration parameters for one or more network entities to improve network coverage for the geographic area. In some implementations, the service may use an artificial intelligence (AI) model to perform the selection. The service may send a command requesting a network entity to update to an antenna configuration parameter. The network entity may update an antenna configuration (such as update an angle of transmission) according to the requested update.

### CROSS REFERENCES

The present Application for Patent claims benefit of U.S. Provisional Patent Application No. 63/750,753 by IZHAKI et al., entitled “RESOLVING NETWORK WEAK SPOTS ACCORDING TO USER EQUIPMENT (UE) DATA,” filed Jan. 28, 2025, assigned to the assignee hereof, and expressly incorporated herein.

### TECHNICAL FIELD

This disclosure relates generally to wireless communication and, more specifically, to resolving network weak spots according to user equipment (UE) data.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a device. The device may include a processing system that includes processor circuitry and memory circuitry that stores code. The processing system may be configured to cause the device to receive data associated with a set of multiple user equipment (UEs) served by a wireless network, the data indicating a geographic area of the wireless network that does not meet a threshold value of a signal quality, a signal strength, a signal throughput, a connection success rate, a setup success rate, or any combination thereof. The processing system may be further configured to cause the device to output (such as transmit, or otherwise send) a command that indicates an update to an antenna configuration parameter for a network entity of the wireless network in accordance with the data, where the update to the antenna configuration parameter for the network entity increases network coverage of the geographic area of the wireless network to meet the threshold value.

Another innovative aspect of the subject matter described in this disclosure can be implemented in a method, such as a method for wireless communication. The method may include receiving data associated with a set of multiple UEs served by a wireless network, the data indicating a geographic area of the wireless network that does not meet a threshold value of a signal quality, a signal strength, a signal throughput, a connection success rate, a setup success rate, or any combination thereof. The method may further include outputting a command that indicates an update to an antenna configuration parameter for a network entity of the wireless network in accordance with the data, where the update to the antenna configuration parameter for the network entity increases network coverage of the geographic area of the wireless network to meet the threshold value.

Another innovative aspect of the subject matter described in this disclosure can be implemented in an apparatus. The apparatus may include means for receiving data associated with a set of multiple UEs served by a wireless network, the data indicating a geographic area of the wireless network that does not meet a threshold value of a signal quality, a signal strength, a signal throughput, a connection success rate, a setup success rate, or any combination thereof. The apparatus may further include means for outputting a command that indicates an update to an antenna configuration parameter for a network entity of the wireless network in accordance with the data, where the update to the antenna configuration parameter for the network entity increases network coverage of the geographic area of the wireless network to meet the threshold value.

Another innovative aspect of the subject matter described in this disclosure can be implemented in a non-transitory computer-readable medium storing code for wireless communications. The code may include instructions executable by one or more processors to receive data associated with a set of multiple UEs served by a wireless network, the data indicating a geographic area of the wireless network that does not meet a threshold value of a signal quality, a signal strength, a signal throughput, a connection success rate, a setup success rate, or any combination thereof. The code may further include instructions executable by the one or more processors to output a command that indicates an update to an antenna configuration parameter for a network entity of the wireless network in accordance with the data, where the update to the antenna configuration parameter for the network entity increases network coverage of the geographic area of the wireless network to meet the threshold value.

In some implementations, the methods, devices, apparatuses, and code may further include operations, features, means, or instructions for selecting a set of multiple impacted tiles, a set of multiple impacted cells, or both in accordance with the network entity being a service provider or an interferer for each impacted tile of the set of multiple impacted tiles, each impacted cell of the set of multiple impacted cells, or both, where an updated measurement of the signal quality, the signal strength, the signal throughput, the connection failure, or any combination thereof may be calculated for the set of multiple impacted tiles, the set of multiple impacted cells, or both in accordance with the update to the antenna configuration parameter for the network entity.

In some implementations, the methods, devices, apparatuses, and code may further include operations, features, means, or instructions for selecting a set of multiple updates to a set of multiple antenna configuration parameters for a set of multiple network entities of the wireless network in accordance with an artificial intelligence (AI) model, where the set of multiple updates to the set of multiple antenna configuration parameters includes the update to the antenna configuration parameter.

In some implementations, the network entity may be outside a threshold distance from the geographic area of the wireless network and the update to the antenna configuration parameter for the network entity decreases coverage by the network entity of at least a portion of the geographic area of the wireless network. In some such implementations, the update to the antenna configuration parameter for the network entity includes a decrease to an angle of transmission for a set of antennas of the network entity.

In some other implementations, the network entity may be within a threshold distance from the geographic area of the wireless network and the update to the antenna configuration parameter for the network entity increases coverage by the network entity of at least a portion of the geographic area of the wireless network. In some such implementations, the update to the antenna configuration parameter for the network entity includes an increase to an angle of transmission for a set of antennas of the network entity.

Another innovative aspect of the subject matter described in this disclosure can be implemented in a network entity of a wireless network. The network entity may include a processing system that includes processor circuitry and memory circuitry that stores code. The processing system may be configured to cause the network entity to obtain (such as receive) a command that indicates an update to an antenna configuration parameter for the network entity, the update to the antenna configuration parameter in accordance with a geographic area of the wireless network that does not meet a threshold value of a signal quality, a signal strength, a signal throughput, a connection success rate, a setup success rate, or any combination thereof. The processing system may be further configured to cause the network entity to update an angle of transmission for a set of antennas of the network entity in accordance with the update to the antenna configuration parameter and communicate in accordance with the updated angle of transmission for the set of antennas.

Another innovative aspect of the subject matter described in this disclosure can be implemented in a method for wireless communications. The method may include obtaining a command that indicates an update to an antenna configuration parameter for the network entity, the update to the antenna configuration parameter in accordance with a geographic area of the wireless network that does not meet a threshold value of a signal quality, a signal strength, a signal throughput, a connection success rate, a setup success rate, or any combination thereof. The method may further include updating an angle of transmission for a set of antennas of the network entity in accordance with the update to the antenna configuration parameter and communicating in accordance with the updated angle of transmission for the set of antennas.

Another innovative aspect of the subject matter described in this disclosure can be implemented in an apparatus for wireless communications. The apparatus may include means for obtaining a command that indicates an update to an antenna configuration parameter for the network entity, the update to the antenna configuration parameter in accordance with a geographic area of the wireless network that does not meet a threshold value of a signal quality, a signal strength, a signal throughput, a connection success rate, a setup success rate, or any combination thereof. The apparatus may further include means for updating an angle of transmission for a set of antennas of the network entity in accordance with the update to the antenna configuration parameter and means for communicating in accordance with the updated angle of transmission for the set of antennas.

Another innovative aspect of the subject matter described in this disclosure can be implemented in a non-transitory computer-readable medium storing code for wireless communications. The code may include instructions executable by one or more processors to obtain a command that indicates an update to an antenna configuration parameter for the network entity, the update to the antenna configuration parameter in accordance with a geographic area of the wireless network that does not meet a threshold value of a signal quality, a signal strength, a signal throughput, a connection success rate, a setup success rate, or any combination thereof. The code may further include instructions executable by the one or more processors to update an angle of transmission for a set of antennas of the network entity in accordance with the update to the antenna configuration parameter and communicate in accordance with the updated angle of transmission for the set of antennas.

In some implementations, the methods, network entities, apparatuses, and code may further include operations, features, means, or instructions for updating a physical antenna configuration, an antenna port configuration, or both for the set of antennas in accordance with the update to the antenna configuration parameter.

In some implementations, the methods, network entities, apparatuses, and code may further include operations, features, means, or instructions for updating a transmit power, an antenna profile, an antenna azimuth, an antenna port configuration, or any combination thereof for the set of antennas in accordance with the update to the antenna configuration parameter.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a pictorial diagram of an example wireless communications system.

FIG. 2 shows an example of a network architecture in a wireless communications system.

FIGS. 3 and 4 show examples of wireless networks that support resolving network weak spots according to user equipment (UE) data.

FIG. 5 shows an example of an antenna configuration update that supports resolving network weak spots.

FIG. 6 shows an example of a process flow that supports resolving network weak spots according to UE data.

FIG. 7 is an illustrative block diagram of an example machine learning (ML) model represented by an artificial neural network (ANN).

FIG. 8 is an illustrative block diagram of an example ML architecture that may be used for wireless communications.

FIG. 9 shows a block diagram of an example device that supports resolving network weak spots according to UE data.

FIG. 10 shows a block diagram of an example network entity that supports resolving network weak spots according to UE data.

FIGS. 11 and 12 show flowcharts illustrating example methods that support resolving network weak spots according to UE data.

Like reference numbers and designations in the various drawings indicate like elements.

### DETAILED DESCRIPTION

The following description is directed to some implementations for the purposes of describing the innovative aspects of this disclosure. However, a person having ordinary skill in the art will readily recognize that the teachings herein can be applied in a multitude of different ways. The described implementations may be implemented in any device, system, or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing third generation (3G), fourth generation (4G), fifth generation (5G), or sixth generation (6G), or further implementations thereof, technology.

Some wireless networks may include geographic areas in which user equipment (UEs) experience relatively poor network coverage. Such a geographic area within a wireless network may be referred to as a network “weak spot.” A service or platform, such as a Device Management and Analytics Platform (DMAP), a service automation, management, and orchestration (SMO) platform, or a combination of such platforms, may collect and analyze data associated with UEs operating within the wireless network. The data associated with the UEs may include location-based information, such as signal measurements, connection events, or other data corresponding to specific geographic locations for the UEs. The service or platform may aggregate the data across UEs (such as aggregating across UEs located within a same tile, aggregating over time, or some combination thereof) to determine (such as select, identify, calculate, or otherwise ascertain) trends for multiple UEs. A trend for multiple UEs may indicate the geographic areas, or network weak spots, in which network coverage is typically degraded.

Various aspects relate generally to improving network coverage, service quality, or both at a network weak spot according to UE data. Some aspects more specifically relate to updating antenna configurations or other parameters for one or more network entities of a wireless network to resolve the network weak spot. A device, such as a device running a radio access network (RAN) application (rApp) or running an automation suite application or otherwise operating as a component of a service or platform (such as an SMO platform), may identify (such as select, determine, calculate, or otherwise ascertain) a network weak spot in accordance with data associated with UEs operating within the wireless network. The device may select (such as determine, identify, calculate, predict, or otherwise ascertain) an update to a parameter of a network entity that mitigates, or otherwise resolves, the network weak spot. The parameter may be an example of an antenna configuration parameter or any other parameter that affects a coverage area (such as a cell footprint) for which the network entity actively provides network coverage. In some implementations, the device may use an artificial intelligence (AI) model, such as a reinforcement learning model or other AI technique, to select the update to the parameter of the network entity. The update to the parameter may be an example of an update to an angle of transmission (such as an up-tilt or down-tilt of an antenna panel), a transmit power, an antenna profile, an antenna azimuth, an antenna port configuration, or any combination thereof. In some implementations, the device (such as using the AI model) may select multiple updates to multiple parameters for one or more network entities of the wireless network. If an update to a parameter satisfies one or more conditions, the device may output a command that indicates the update to the parameter. For example, the device may update the parameter at a mobile network operator (MNO) or element management system (EMS) for the wireless network, a core network of the wireless network, one or more network entities of the wireless network, or any combination thereof, and the MNO or EMS may output the command to one or more network entities to perform the corresponding parameter update. A network entity may obtain the command indicating the update to the parameter for the network entity and may update a configuration (such as an antenna configuration or a measurement event configuration) in accordance with the update to the parameter. Updating the configuration at the network entity may affect coverage of the network weak spot. For example, if the network entity is within a threshold distance from the network weak spot, the update to the configuration may increase an angle of transmission for the network entity, enabling the network entity to establish connections with UEs operating within the network weak spot. Alternatively, if the network entity is outside the threshold distance from the network weak spot, the update to the configuration may decrease the angle of transmission for the network entity, removing connections between the network entity and UEs operating within the network weak spot. In some implementations, the wireless network may update configurations, such as antenna configurations, at multiple network entities.

Particular aspects of the subject matter described in this disclosure can be implemented to realize one or more of the following potential advantages. By updating the configurations for one or more network entities, the described techniques can be used to resolve, or otherwise mitigate or improve, a network weak spot. For example, by increasing an angle of transmission for a network entity that is located within the threshold distance from the network weak spot, the wireless network may improve the likelihood that the network entity (such as a natural serving cell for the geographic area including the network weak spot) provides network service for UEs operating within the network weak spot. Additionally, or alternatively, by decreasing an angle of transmission for a network entity that is located outside the threshold distance from the network weak spot, the wireless network may decrease the likelihood that the network entity (such as an interferer for the geographic area including the network weak spot) provides network service for UEs operating within the network weak spot. The antenna configuration updates may cause a natural serving cell, instead of an interferer, to provide network coverage for the network weak spot, effectively decreasing the distance between the network entity operating as the serving cell and the UEs being served by the network entity (such as within the network weak spot). Decreasing the distance between the serving cell and the network weak spot may improve a signal quality, a signal strength, a signal throughput, or any combination thereof for UEs operating within the network weak spot. Additionally, or alternatively, decreasing the distance between the serving cell and the network weak spot may reduce a quantity of connection failures (and, correspondingly, improve a connection success rate), reduce a quantity of setup failures (and, correspondingly, improve a setup success rate), or both experienced by UEs operating within the network weak spot. In some implementations, by using an AI model to optimize (or otherwise improve) the antenna configurations across multiple network entities, the wireless network may improve the network weak spots without introducing new coverage gaps or network weak spots elsewhere within the wireless network. Additionally, or alternatively, by updating the antenna configurations if the update satisfies one or more conditions, the wireless network may improve a processing overhead by avoiding (such as refraining from) performing negligible antenna configuration updates, such as updates that offer relatively small improvements to the network coverage. For example, such updates may fail to satisfy at least one condition of the one or more conditions.

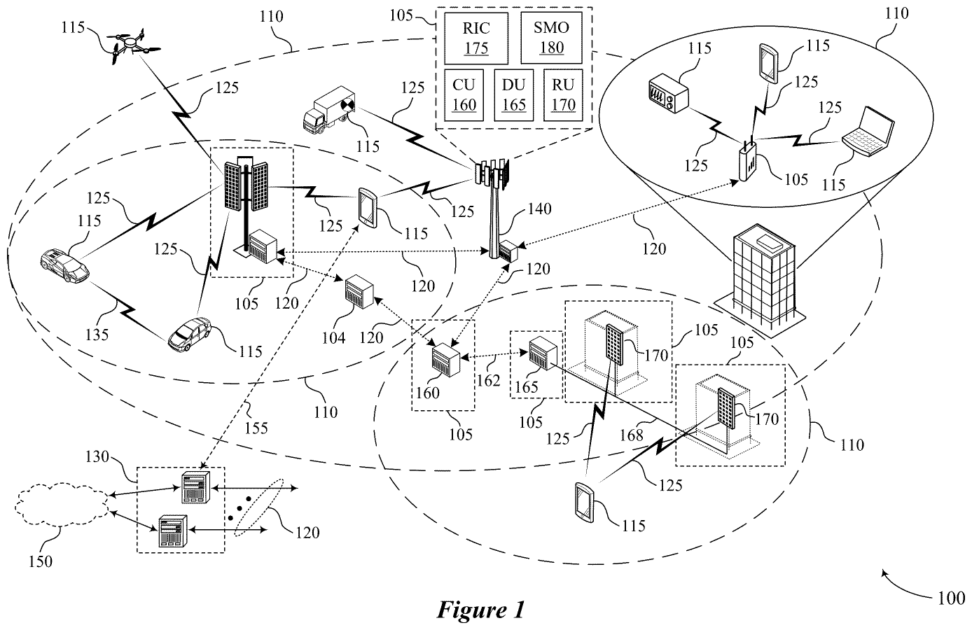

FIG. 1 shows a pictorial diagram of an example wireless communications system 100. The wireless communications system 100 may include one or more devices, such as one or more network devices (such as network entities 105), one or more UEs 115, and a core network 130. In some implementations, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a RAN node, or network equipment, among other nomenclature. In some implementations, network entities 105 and UEs 115 may wirelessly communicate via communication link(s) 125 (such as a radio frequency (RF) access link). For example, a network entity 105 may support a coverage area 110 (such as a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (such as other wireless communication devices, including UEs 115 or network entities 105), as shown in FIG. 1.

As described herein, a node of the wireless communications system 100, which may be referred to as a network node, or a wireless node, may be a network entity 105 (such as any network entity described herein), a UE 115 (such as any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some implementations, network entities 105 may communicate with a core network 130, or with one another, or both. For example, network entities 105 may communicate with the core network 130 via backhaul communication link(s) 120 (such as in accordance with an S1, N2, N3, or other interface protocol). In some implementations, network entities 105 may communicate with one another via backhaul communication link(s) 120 (such as in accordance with an X2, Xn, or other interface protocol) either directly (such as directly between network entities 105) or indirectly (such as via the core network 130). In some implementations, network entities 105 may communicate with one another via a midhaul communication link 162 (such as in accordance with a midhaul interface protocol) or a fronthaul communication link 168 (such as in accordance with a fronthaul interface protocol), or any combination thereof. The backhaul communication link(s) 120, midhaul communication links 162, or fronthaul communication links 168 may be or include one or more wired links (such as an electrical link, an optical fiber link) or one or more wireless links (such as a radio link, a wireless optical link), among other examples or various combinations thereof. A UE 115 may communicate with the core network 130 via a communication link 155.

One or more of the network entities 105 or network equipment described herein may include or may be referred to as a base station 140 (such as a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some implementations, a network entity 105 (such as a base station 140) may be implemented in an aggregated (such as monolithic, standalone) base station architecture, which may be configured to utilize a protocol stack that is physically or logically integrated within one network entity (such as a network entity 105 or a single RAN node, such as a base station 140).

In some implementations, a network entity 105 may be implemented in a disaggregated architecture (such as a disaggregated base station architecture, a disaggregated RAN architecture), which may be configured to utilize a protocol stack that is physically or logically distributed among multiple network entities (such as network entities 105), such as an integrated access and backhaul (IAB) network, an open RAN (O-RAN) (such as a network configuration sponsored by the O-RAN Alliance), or a virtualized RAN (vRAN) (such as a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (such as a Near-Real Time RIC (Near-RT RIC), a Non-Real Time RIC (Non-RT RIC)), an SMO system, such as an SMO system 180, or any combination thereof. An RU 170 also may be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (such as separate physical locations). In some implementations, one or more of the network entities 105 of a disaggregated RAN architecture may be implemented as virtual units (such as a virtual CU (VCU), a virtual DU (VDU), a virtual RU (VRU)).

The split of functionality between a CU 160, a DU 165, and an RU 170 is flexible and may support different functionalities depending on which functions (such as network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some implementations, the CU 160 may host upper protocol layer (such as layer 3 (L3), layer 2 (L2)) functionality and signaling (such as Radio Resource Control (RRC), service data adaptation protocol (SDAP), Packet Data Convergence Protocol (PDCP)). The CU 160 (such as one or more CUs) may be connected to a DU 165 (such as one or more DUs) or an RU 170 (such as one or more RUs), or some combination thereof, and the DUs 165, RUs 170, or both may host lower protocol layers, such as layer 1 (L1) (such as physical (PHY) layer) or L2 (such as radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (such as via one or multiple different RUs, such as an RU 170). In some implementations, a functional split between a CU 160 and a DU 165 or between a DU 165 and an RU 170 may be within a protocol layer (such as some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (such as F1, F1-c, F1-u), and a DU 165 may be connected to an RU 170 via a fronthaul communication link 168 (such as open fronthaul (FH) interface). In some implementations, a midhaul communication link 162 or a fronthaul communication link 168 may be implemented in accordance with an interface (such as a channel) between layers of a protocol stack supported by respective network entities (such as one or more of the network entities 105) that are in communication via such communication links.

In some wireless communications systems (such as the wireless communications system 100), infrastructure and spectral resources for radio access may support wireless backhaul link capabilities to supplement wired backhaul connections, providing an IAB network architecture (such as to a core network 130). In some implementations, in an IAB network, one or more of the network entities 105 (such as network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (such as IAB donors) may be in communication with one or more additional devices (such as IAB node(s) 104) via supported access and backhaul links (such as backhaul communication link(s) 120). IAB node(s) 104 may include an IAB mobile termination (IAB-MT) controlled (such as scheduled) by one or more DUs (such as DUs 165) of a coupled IAB donor. An IAB-MT may be equipped with an independent set of antennas for relay of communications with UEs 115 or may share the same antennas (such as of an RU 170) of IAB node(s) 104 used for access via the DU 165 of the IAB node(s) 104 (such as referred to as virtual IAB-MT (vIAB-MT)). In some implementations, the IAB node(s) 104 may include one or more DUs (such as DUs 165) that support communication links with additional entities (such as IAB node(s) 104, UEs 115) within the relay chain or configuration of the access network (such as downstream). In such cases, one or more components of the disaggregated RAN architecture (such as the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support resolving network weak spots according to UE data as described herein. For example, some operations described as being performed by a UE 115 or a network entity 105 (such as a base station 140) may additionally, or alternatively, be performed by one or more components of the disaggregated RAN architecture (such as components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” also may be referred to as a unit, a station, a terminal, or a client, among other examples. A UE 115 also may include or may be referred to as a personal electronic device such as a cellular phone, a personal digital assistant (PDA), a tablet computer, a laptop computer, or a personal computer. In some implementations, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (such as one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (such as a bandwidth part (BWP)) that is operated according to one or more PHY layer channels for a given RAT (such as LTE, LTE-A, LTE-A Pro, NR). Each PHY layer channel may carry acquisition signaling (such as synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (such as entity, sub-entity) of a network entity 105. For example, the terms “transmitting,” “receiving,” or “communicating,” when referring to a network entity 105, may refer to any portion of a network entity 105 (such as a base station 140, a CU 160, a DU 165, a RU 170) of a RAN communicating with another device (such as directly or via one or more other network entities, such as one or more of the network entities 105).

Signal waveforms transmitted via a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (such as a duration of one modulation symbol) and one subcarrier, in which case the symbol period and subcarrier spacing may be inversely related. The quantity of bits carried by each resource element may depend on the modulation scheme (such as the order of the modulation scheme, the coding rate of the modulation scheme, or both), such that a relatively higher quantity of resource elements (such as in a transmission duration) and a relatively higher order of a modulation scheme may correspond to a relatively higher rate of communication. A wireless communications resource may refer to a combination of an RF spectrum resource, a time resource, and a spatial resource (such as a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (such as 10 milliseconds (ms)). Each radio frame may be identified by a system frame number (SFN) (such as ranging from 0 to 1023).

Each frame may include multiple consecutively-numbered subframes or slots, and each subframe or slot may have the same duration. In some implementations, a frame may be divided (such as in the time domain) into subframes, and each subframe may be further divided into a quantity of slots. Alternatively, each frame may include a variable quantity of slots, and the quantity of slots may depend on subcarrier spacing. Each slot may include a quantity of symbol periods (such as depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (such as N_{f}) sampling periods. The duration of a symbol period may depend on the subcarrier spacing or frequency band of operation.

A subframe, a slot, a mini-slot, or a symbol may be the smallest scheduling unit (such as in the time domain) of the wireless communications system 100 and may be referred to as a transmission time interval (TTI). In some implementations, the TTI duration (such as a quantity of symbol periods in a TTI) may be variable. Additionally, or alternatively, the smallest scheduling unit of the wireless communications system 100 may be dynamically selected (such as in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (such as a control resource set (CORESET)) for a physical control channel may be defined by a set of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (such as control channel elements (CCEs)) associated with encoded information for a control information format having a given payload size. Search space sets may include common search space sets configured for sending control information to UEs 115 (such as one or more UEs) or may include UE-specific search space sets for sending control information to a UE 115 (such as a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (such as using a carrier) and may be associated with an identifier for distinguishing neighboring cells (such as a physical cell identifier (PCID), a virtual cell identifier (VCID)). In some implementations, a cell also may refer to a coverage area 110 or a portion of a coverage area 110 (such as a sector) over which the logical communication entity operates. Such cells may range from smaller areas (such as a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (such as several kilometers in radius) and may allow unrestricted access by the UEs 115 with service subscriptions with the network provider supporting the macro cell. A small cell may be associated with a network entity 105 operating with lower power (such as a base station 140 operating with lower power) relative to a macro cell, and a small cell may operate using the same or different (such as licensed, unlicensed) frequency bands as macro cells. Small cells may provide unrestricted access to the UEs 115 with service subscriptions with the network provider or may provide restricted access to the UEs 115 having an association with the small cell (such as the UEs 115 in a closed subscriber group (CSG), the UEs 115 associated with users in a home or office). A network entity 105 may support one or more cells and also may support communications via the one or more cells using one or multiple component carriers.

In some implementations, a network entity 105 (such as a base station 140, an RU 170) may be movable and therefore provide communication coverage for a moving coverage area, such as the coverage area 110. In some implementations, coverage areas 110 (such as different coverage areas) associated with different technologies may overlap, but the coverage areas 110 (such as different coverage areas) may be supported by the same network entity (such as a network entity 105). In some other implementations, overlapping coverage areas, such as a coverage area 110, associated with different technologies may be supported by different network entities (such as the network entities 105). The wireless communications system 100 may include, for example, a heterogeneous network in which different types of the network entities 105 support communications for coverage areas 110 (such as different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some implementations, a UE 115 may be configured to support communicating directly with other UEs (such as one or more of the UEs 115) via a device-to-device (D2D) communication link, such as a D2D communication link 135 (such as in accordance with a peer-to-peer (P2P), D2D, or sidelink protocol). In some implementations, one or more UEs 115 of a group that are performing D2D communications may be within the coverage area 110 of a network entity 105 (such as a base station 140, an RU 170), which may support aspects of such D2D communications being configured by (such as scheduled by) the network entity 105. In some implementations, one or more UEs 115 of such a group may be outside the coverage area 110 of a network entity 105 or may be otherwise unable to or not configured to receive transmissions from a network entity 105. In some implementations, groups of the UEs 115 communicating via D2D communications may support a one-to-many (1:M) system in which each UE 115 transmits to one or more of the UEs 115 in the group. In some implementations, a network entity 105 may facilitate the scheduling of resources for D2D communications. In some other implementations, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (such as base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (such as less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some implementations, operations using unlicensed bands may be in accordance with a carrier aggregation configuration in conjunction with component carriers operating using a licensed band (such as LAA). Operations using unlicensed spectrum may include downlink transmissions, uplink transmissions, P2P transmissions, or D2D transmissions, among other examples.

A network entity 105 (such as a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some implementations, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which also may be referred to as spatial filtering, directional transmission, or directional reception, is a signal processing technique that may be used at a transmitting device or a receiving device (such as a network entity 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

The wireless communications system 100, or another service or platform, may collect data associated with UEs 115 operating within the wireless communications system 100 (such as a wireless network). For example, a DMAP may collect data, including location-based data, associated with UEs 115. In some implementations, the DMAP (such as a server, database, or other device running, or otherwise supporting, the DMAP) may receive device-level data for the UEs 115 via a wireless connection, such as a cellular or Wi-Fi connection. For example, the DMAP may collect the data directly from the UEs 115 or via one or more network entities 105 communicating with the UEs 115, from one or more other devices or entities, or any combination thereof. The data may indicate geographic areas within the wireless communications system 100 that are network weak spots.

A service or platform, such as a RAN SMO platform, an rApp including one or more algorithms or AI components, an automation suite application, or any other platform or application, may analyze the UE data, network data, or some combination thereof collected by the DMAP to determine (such as identify, select, predict, or otherwise ascertain) one or more network updates that may resolve one or more network weak spots. In some implementations, a network update may improve cell planning by increasing network coverage for the wireless communications system 100 as a whole. For example, the network update may modify coverage areas for multiple network entities 105, such that the combination of coverage areas (or the quality of service provided in the combination of coverage areas) for the multiple network entities 105 is improved. In some implementations, the service or platform (such as the RAN SMO platform or the automation suite application) may send an indication of the network update to the wireless communications system 100. For example, the service or platform may send the indication to an operator of the wireless communications system 100, to the core network 130 (such as to the MME), to a management system associated with the wireless communications system 100, to one or more network entities 105 (such as directly to one or more eNBs, one or more gNBs, or both), or some combination thereof. The wireless communications system 100 may update the configurations of one or more network entities 105 according to the network update to resolve (such as improve coverage for, improve average throughput for, improve average signal quality or strength for) the one or more network weak spots.

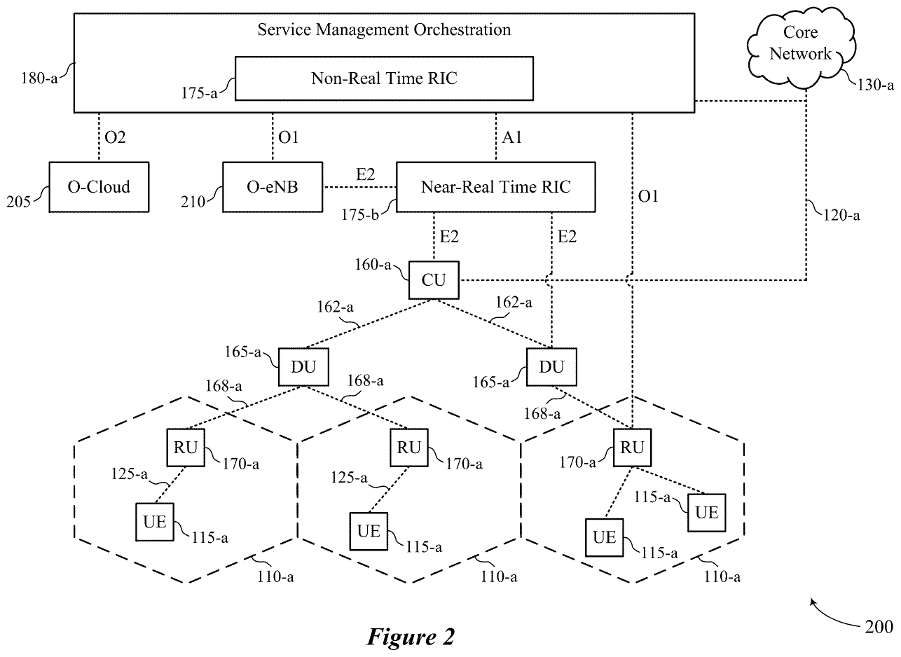

FIG. 2 shows an example of a network architecture 200 in a wireless communications system. The network architecture 200 may be an example of a disaggregated base station architecture, a disaggregated RAN architecture, or both. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (such as a Near-RT RIC 175-b via an E2 link, or a Non-RT RIC 175-a associated with an SMO 180-a (such as an SMO Framework), or both). A CU 160-a may communicate with one or more DUs 165-a via respective midhaul communication links 162-a (such as an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (such as CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (such as data, information) via a wired or wireless transmission medium. Each network entity 105, or an associated processor (such as controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (such as an RF transceiver) configured to receive or transmit signals, or both, over a wireless transmission medium to one or more of the other network entities 105.

In some implementations, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (such as CU-UP), control plane functionality (such as CU-CP), or a combination thereof. In some implementations, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a for network control and signaling.

A DU 165-a may correspond to a logical unit that includes one or more functions (such as base station functions, RAN functions) to control the operation of one or more RUs 170-a. In some implementations, a DU 165-a may host, at least partially, one or more of an RLC layer, a MAC layer, and one or more aspects of a PHY layer (such as a high PHY layer, such as modules for FEC encoding and decoding, scrambling, modulation and demodulation, or the like) depending, at least in part, on a functional split, such as those defined by the 3rd Generation Partnership Project (3GPP). In some implementations, a DU 165-a may further host one or more low PHY layers. Each layer may be implemented with an interface configured to communicate signals with other layers hosted by the DU 165-a, or with control functions hosted by a CU 160-a.

In some implementations, lower-layer functionality may be implemented by one or more RUs 170-a. For example, an RU 170-a, controlled by a DU 165-a, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, in accordance with the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some implementations, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage which may be managed via an operations and maintenance interface (such as an O1 interface). For virtualized network entities 105, the SMO 180-a may be configured to interact with a cloud computing platform (such as an O-Cloud 205) to perform network entity life cycle management (such as to instantiate virtualized network entities 105) via a cloud computing platform interface (such as an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (such as via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (such as via an A1 interface) the Near-RT RIC 175-b. The Near-RT RIC 175-b may be configured to include a logical function that enables near-real-time control and optimization of RAN elements and resources via data collection and actions over an interface (such as via an E2 interface) connecting one or more CUs 160-a, one or more DUs 165-a, or both, as well as an O-eNB 210, with the Near-RT RIC 175-b.

In some implementations, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some implementations, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (such as reconfiguration via 01) or via generation of RAN management policies (such as A1 policies).

In some implementations, a wireless network may update one or more network entities 105 of the network architecture 200, such as CUs 160-a, DUs 165-a, RUs 170-a, or any combination thereof. For example, the wireless network may receive an indication to update a network configuration to resolve a network weak spot. The wireless network may trigger an update at one or more CUs 160-a, one or more DUs 165-a, one or more RUs 170-a, or any combination thereof. In some implementations, the network update may be an example of an update to an antenna configuration parameter (such as a tilt of an antenna panel or set of antennas). One or more RUs 170-a may update an antenna configuration in accordance with the update to the antenna configuration parameter.

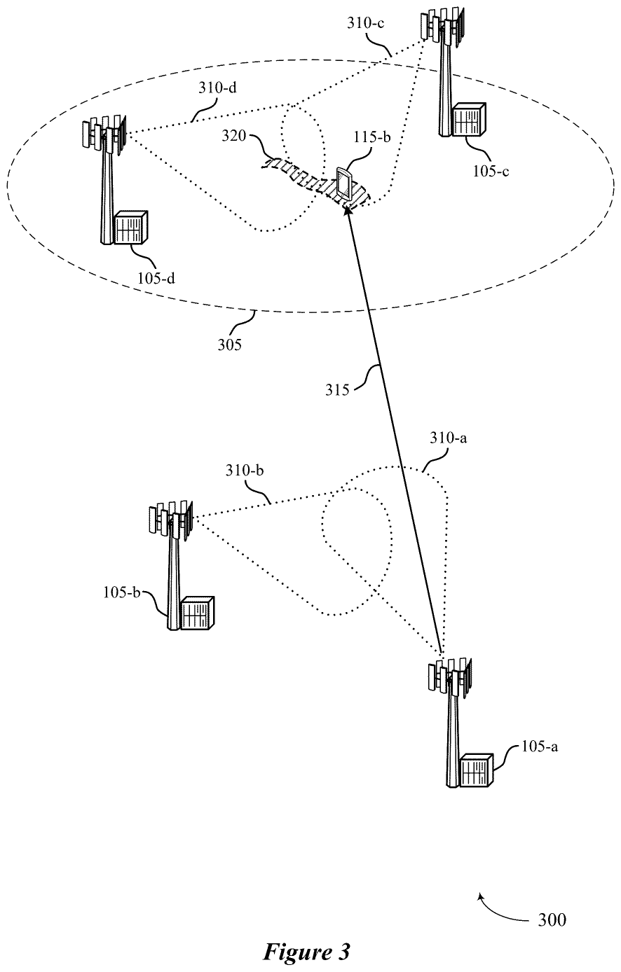

FIG. 3 shows an example of a wireless network 300 that supports resolving network weak spots according to UE data. The wireless network 300 may be an example or component of a wireless communications system 100 as described with reference to FIG. 1. The wireless network 300 may be configured in accordance with the network architecture 200 as described with reference to FIG. 2. The wireless network 300 may include multiple network entities 105 that coordinate to provide network coverage for a geographic area. For example, the wireless network 300 may include a first network entity 105-a, a second network entity 105-b, a third network entity 105-c, and a fourth network entity 105-d. In some implementations, a service or platform, such as a DMAP, may collect data associated with UEs 115 operating within the wireless network 300. A service or platform (such as the same service or platform or a different service or platform), such as an SMO or automation suite application (for example, using an rApp), may aggregate and analyze the UE data (such as DMAP data or other device-level data) to select (such as determine, calculate, or otherwise ascertain) one or more parameter updates to improve the coverage of the wireless network 300. In some implementations, the DMAP may collect the UE data and the SMO may receive and analyze the UE data collected by the DMAP. The rApp may include one or more algorithms or AI components for analyzing, or otherwise processing, the UE data.

The service or platform may receive data associated with multiple UEs 115. For example, the service or platform may receive the UE data via cell-based telemetry. In some implementations, the service or platform may receive the UE data from one or more network entities 105 serving one or more respective cells. In some other implementations, the service or platform may receive the UE data from the corresponding UEs 115. The service or platform may collect any device-level data from one or more sources. For example, the service or platform may receive crowd-sourced data across multiple UEs 115 (such as from a crowd-sourcing application or service for mobile devices), probe device data from one or more probes operating on one or more interfaces between network entities 105 and a core network (such as the core network 130), traces indicating network events that are tracked by an operations support system (OSS) or one or more other systems and may be parsed to indicate telemetries for multiple UEs 115, minimization of drive test (MDT) data indicating field measurements (such as radio measurements, location information, or both) for multiple devices within the wireless network 300, performance information for multiple UEs 115, or any combination of these or other device-level data. The UE data may include location-based information, time-based information, or both. For example, the UE data may indicate UE measurements and indications of the locations (such as Global Positioning System (GPS) coordinates, cell locations, or other location-based information) at which the UE measurements were performed, the times (such as timestamps, clock values, or other time-based information) at which the UE measurements were performed, or both. One or more UE measurements may indicate an expected, predicted, or actual user experience. For example, the UE measurements may include signal quality measurements (such as reference signal received quality (RSRQ) measurements), signal strength measurements (such as reference signal received power (RSRP) measurements, received signal strength indicator (RSSI) measurements, signal-to-noise ratio (SNR) measurements, signal-to-interference plus noise ratio (SINR) measurements), signal throughput measurements, connection failure measurements (such as a quantity of radio link failures (RLFs) or random access channel (RACH) failures within a time period), or any combination thereof. If a UE measurement does not meet, or otherwise fails to satisfy, a threshold value or other key performance indicator (KPI) range, a UE 115 performing the UE measurement may experience a relatively degraded network performance and, correspondingly, a negative user experience. In some implementations, the performance may degrade such that the wireless network 300 may drop (such as deactivate or reject) a connection with the UE 115.

Some geographic areas within the wireless network 300 may include a relatively high density of UEs 115 experiencing relatively poor network performance. Such an area may be referred to as a network weak spot 320. That is, from a user perspective, UEs 115 operating within a network weak spot 320 may operate with a relatively poor user experience. UEs 115 may experience a relatively high quantity of weak spot events while operating within the network weak spot 320. A weak spot event may include an RLF, a coverage gap in accordance with a signal strength or quality metric failing to meet a threshold value, a RACH failure, low throughput (such as below a threshold throughput value), or any combination of these or other events indicating relatively poor network coverage of the network weak spot 320. The service or platform may select (such as determine, identify, or otherwise ascertain) one or more network weak spots 320 in accordance with the data associated with the UEs 115 operating within the wireless network 300. The service or platform may aggregate UE data within a tile (such as a specific geographic location or unit), within a time period (such as a specific time period or interval), or both to select (such as determine, identify, or otherwise ascertain) the network weak spots 320. A tile may be an example of a unit of area, such as a 6 meter by 6 meter square or a 10 meter by 10 meter square. In some implementations, the tile resolution (such as the size of a tile) may be static or dynamic. In some implementations, the service or platform may combine UE data (such as DMAP data) with network data (such as data provided by one or more network entities 105) to select the one or more network weak spots 320.

In some implementations, relatively inefficient cell planning for the wireless network 300 may at least partially cause a network weak spot 320. Inefficient cell planning may result in exclusion of missing neighbor cells, physical cell identity (PCI) collisions, root sequence index (RSI) collisions, hardware malfunctions, or other events that may cause the network weak spot 320. For example, a network entity 105-c and a network entity 105-d may be located relatively close to the network weak spot 320. Such network entities may be examples of natural serving cells for the network weak spot 320. A natural serving cell may be an example of a network entity 105 or cell that is located within a threshold distance 305 from the network weak spot 320. In some implementations, the threshold distance 305 may be dynamic (such as non-static). For example, network entities 105 located at sites of a “first tier” may be natural serving cells for the network weak spot 320, even though the network entities 105 may be located at different distances from the network weak spot 320. The “first tier” sites may further depend on a direction from the network weak spot 320, obstructions or other geometries (such as buildings or other structures) located relatively near the network weak spot 320, or any combination thereof. Network entities that are located outside of the threshold distance 305 but serve UEs 115 within the network weak spot 320 may be examples of interferers or over-shooters. For example, a network entity 105-a may establish a connection 315 with a UE 115-b within the network weak spot 320. The distance from the network entity 105-a to the UE 115-b may result in a relatively poor signal strength, signal quality, or both for the connection 315. The network entity 105-a commonly connecting with UEs 115 operating at a significant distance from the network entity 105-a may cause or contribute to the network weak spot 320.

In some implementations, the threshold distance 305 may be measured in terms of decibels (dBs) or decibel-milliwatts (dBm), or the interferers or over-shooters may be defined in terms of dBs or dBm. For example, the threshold distance 305 may identify (such as define or indicate) natural serving cells as cells or network entities 105 that operate within the threshold distance 305. For example, the network entity 105-c may be the natural serving cell for the UE 115-b. Cells or network entities 105 that serve UEs 115 located within the network weak spot 320 at a distance of X dBs (such as 3 dBs, 4 dBs, 5 dBs, or any other value that may be statically or dynamically configured) may be identified (such as defined or indicated) as interferers or over-shooters. For example, the network entity 105-a may be an interferer or over-shooter for the UE 115-b if the network entity 105-a serves the UE 115-b from outside the threshold distance 305. The network entity 105-c may serve UEs 115 in a geographic area relatively near the network weak spot 320 with a connection that supports an RSRP value of −80 dBm. Cells or network entities outside the threshold distance 305 may establish connections with UEs within this geographic areas that support RSRP values within 4 dBm from −80 dBm (such as from −80 dBm to −84 dBm) and, accordingly, may be referred to as interferers (such as interfering with the network coverage provided by the natural serving cells) or over-shooters (such as over-shooting a geographic area for which the cell or network entity operates as a natural serving cell). For example, such cells or network entities operating as interferers or over-shooters for the UE 115-b may create noise within the network weak spot 320 that negatively affects the UE 115-b. The wireless network 300 may support other RSRP threshold distances 305, such as 3 dBm, 5 dBm, or any other value configured for the wireless network 300. In some implementations, the service or platform may tune (such as configure) the threshold distance 305 value according to one or more measurements, an environment, or any other parameters.

The service or platform (such as the SMO, the automation suite application, or a combination thereof) may select (such as detect, determine, identify, recognize, or otherwise ascertain) the network weak spot 320 in accordance with UE data, network data, or both. The service or platform may analyze the network weak spot 320 (such as using a weak spot tile analysis) and select (such as determine, identify, or otherwise ascertain) the serving cells contributing to the network weak spot 320. In some implementations, the service or platform may select (such as determine, identify, or otherwise ascertain) a quantity of next-best cells for the network weak spot 320. In some implementations, the service or platform may perform a geographic analysis to select (such as determine, identify, recognize, categorize, or otherwise ascertain) the natural serving cells and the interferers for the network weak spot 320. The geographic analysis may select (such as identify, determine, or otherwise ascertain) geographic areas that correspond to the natural serving cells and the interferers. For example, the service or platform may select the network entity 105-c and the network entity 105-d as natural serving cells for the network weak spot 320 and may select the network entity 105-a as an interferer for the network weak spot 320.

In some implementations, the network entity 105-a may service the network weak spot 320 in accordance with an antenna configuration of the network entity 105-a, the network entity 105-c, the network entity 105-d, or some combination thereof. For example, an angle of transmission or an angle of reception for the network entity 105-a may enable the network entity 105-a to establish the connection 315 with the UE 115-b in the network weak spot 320. In contrast, an angle of transmission or an angle of reception for the network entity 105-c may fail to support establishing a connection with the UE 115-b in accordance with a sub-optimal plan for the antenna configuration of the network entity 105-c, one or more obstacles, obstructions, interferers, or other entities affecting the coverage of the network entity 105-c, or any combination thereof.

The service or platform (such as the SMO) may select (such as determine, calculate, configure, or otherwise ascertain) one or more updates to antenna configuration parameters or other parameters to mitigate the network weak spot 320 (such as improve user experience in the geographic area of the network weak spot 320). In some implementations, the service or platform may use one or more AI components to select the one or more updates to parameters. The service or platform may select an update to any parameter that affects the network service for the network weak spot 320 (such as any service metrics or cell service identifiers (IDs) for the network weak spot 320). For example, the parameter may affect the coverage area for which a network entity 105 actively provides network coverage (such as the area where the network entity 105 is a “best” server according to one or more metrics), which may be referred to as the cell footprint of the network entity 105. In some implementations, the parameter may be an example of an antenna configuration parameter for the network entity 105 or may be an example of a measurement event parameter. The service or platform may select an update to an angle of transmission (such as an angle of transmission, an angle of reception, or both), a transmit power, an antenna profile, an antenna azimuth, an antenna port configuration, or any combination thereof for an antenna configuration at the network entity 105 (such as at a base station or other network device). The service or platform may analyze the effects of such updates to the wireless network 300 (such as across any geographic areas or cells affected by the updates).

In some implementations, the one or more updates to antenna configuration parameters may include a down-tilt of an angle of transmission or an angle of reception for an antenna panel or set of antennas at the network entity 105-a (such as an interferer). The down-tilt may involve decreasing the angle of transmission or angle of reception at the network entity 105-a to decrease an expected service range 310-a for the network entity 105-a and, correspondingly, reduce a likelihood that the network entity 105-a establishes a connection 315 with UEs 115 located within the network weak spot 320. For example, the down-tilting may reduce a capability or likelihood of the network entity 105-a providing service significantly beyond its expected service range 310-a. The down-tilting may increase, for the network weak spot 320, an attenuation value for signals transmitted by the network entity 105-a, reducing the noise caused by the network entity 105-a at the network weak spot 320. Additionally, or alternatively, the one or more updates to antenna configuration parameters may include an up-tilt of an angle of transmission or an angle of reception for an antenna panel or set of antennas at the network entity 105-c, the network entity 105-d, or both (such as the natural serving cells). The up-tilt may involve increasing the angle of transmission or angle of reception at the network entity 105-c, the network entity 105-d, or both to increase an expected service range 310-c, an expected service range 310-d, or both and, correspondingly, improve a likelihood that the network entity 105-c, the network entity 105-d, or both establish connections with UEs 115 located within the network weak spot 320. The up-tilting may decrease, for the network weak spot 320, an attenuation value for signals transmitted by the network entity 105-c, the network entity 105-d, or both.

In some implementations, the one or more updates to antenna configuration parameters may affect other areas within the wireless network 300. For example, down-tilting the angle of transmission at the network entity 105-a may decrease the expected service range 310-a for the network entity 105-a. To mitigate potential negative effects of this update (such as avoid coverage gaps or introducing new network weak spots 320), the one or more updates to antenna configuration parameters may include updates to other network entities 105 within the wireless network 300. For example, the one or more updates to antenna configuration parameters may update an antenna configuration at the network entity 105-b to compensate for the change in network coverage provided by the network entity 105-a. In some implementations, the network entity 105-b may be referred to as an interferer compensator. For example, the one or more updates may up-tilt an angle of transmission or angle of reception at the network entity 105-b and, correspondingly, increase an expected service range 310-b) to improve network coverage in areas affected by the down-tilting at the network entity 105-a.

In some implementations, the service or platform may select (such as predict, calculate, determine, or otherwise ascertain) the one or more updates to antenna configuration parameters using DMAP data. For example, the service or platform may perform the selection using DMAP data in accordance with a geometry antenna pattern calculation. The service or platform may calculate (such as determine, estimate, select, or otherwise ascertain) signal measurements, such as signal strength, signal quality, signal throughput, SINR, or any combination thereof for areas affected within the wireless network 300. The service or platform also may update an AI component, such as an artificial neural network (ANN), that predicts coverage increases and decreases in accordance with the one or more updates to antenna configuration parameters or any other parameters that impact a cell footprint in the wireless network 300. Additionally, or alternatively, the service or platform may select (such as predict, calculate, determine, or otherwise ascertain) the one or more updates to antenna configuration parameters or other parameters using an RF network model of the wireless network 300. For example, an RF network model may be a digital representation of the wireless network 300 (or at least some aspects or metrics of the wireless network 300, such as an RSRP or SINR model) on a tile-level basis that may predict the impact of updates to the wireless network 300. In some implementations, updates to the RF network model may be propagated to the wireless network 300 via an EMS. For example, if the service or platform updates a parameter in the EMS for a digital version of a network entity, the EMS may output a command to the corresponding actual network entity to perform the corresponding update. The service or platform may use an antenna pattern geometry calculation, Ray Trace modeling with the RF network model to predict RSRP or other metric changes, or both to predict (such as calculate, determine, or otherwise ascertain) how the one or more updates to antenna configuration parameters may affect the network coverage.

The effect on network coverage, network quality, overall network impact, or any combination thereof may be measured according to impacted tiles (such as geographic area units), impacted cells, or both. In some implementations, the service or platform may determine (such as select, calculate, estimate, or otherwise ascertain) the impact of the one or more updates to antenna configuration parameters according to a cell footprint of DMAP measurements. The updates may impact a tile if the updates cause a change to a serving cell (or best server), a neighbor cell, a detected cell (such as interferer) or any combination thereof for the tile (such as a geographic area unit). The updates may impact a cell if the updates cause the cell to become a serving cell (or best server) for an impacted tile, become an interferer for an impacted tile, or both. The service or platform may use the impacted tiles, the impacted cells, or both to determine (such as track, calculate, predict, or otherwise ascertain) the effects of the updates to the wireless network 300. For example, the updates may impact multiple tiles, cells, and network entities 105 within the wireless network 300.

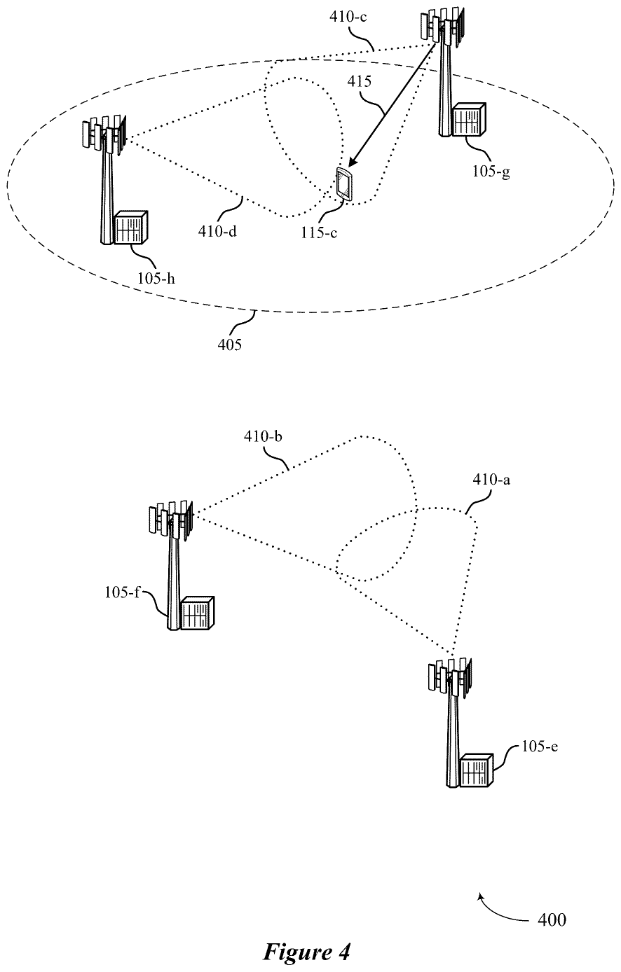

FIG. 4 shows an example of a wireless network 400 that supports resolving network weak spots according to UE data. The wireless network 400 may be an example or component of a wireless communications system 100 as described with reference to FIG. 1 or a wireless network 300 as described with reference to FIG. 3. The wireless network 400 may be configured in accordance with the network architecture 200 as described with reference to FIG. 2. The wireless network 400 may include multiple network entities 105 that coordinate to provide network coverage for a geographic area. For example, the wireless network 400 may include a first network entity 105-e, a second network entity 105-f, a third network entity 105-g, and a fourth network entity 105-h. In some implementations, the first network entity 105-e may be an example of a first network entity 105-a, the second network entity 105-f may be an example of a second network entity 105-b, the third network entity 105-g may be an example of a third network entity 105-c, and the fourth network entity 105-h may be an example of a fourth network entity 105-d as described with reference to FIG. 3. A service or platform, such as an SMO or rApp, may indicate one or more updates to parameters for the wireless network 400 as described with reference to FIG. 3.

The wireless network 400 may perform the one or more updates to parameters (such as one or more cell configuration changes, antenna configuration changes, or other parameter changes) at one or more network entities 105 to resolve, or otherwise improve network coverage at, a network weak spot. For example, the network entity 105-e may decrease an angle of transmission to reduce an expected service range 410-a for the network entity 105-e. The network entity 105-e may disconnect from a UE 115-c operating within a previous network weak spot according to the reduction of the expected service range 410-a. The network entity 105-f may increase an angle of transmission to increase an expected service range 410-b for the network entity 105-f and at least partially compensate for the reduction of the expected service range 410-a. The network entity 105-g may increase an angle of transmission to increase an expected service range 410-c for the network entity 105-g, and the network entity 105-h may increase an angle of transmission to increase an expected service range 410-d for the network entity 105-h. The network entity 105-g may establish a connection 415 with the UE 115-c in accordance with the increase to the expected service range 410-c, the decrease to the expected service range 410-a, or both. The network entity 105-g may be within a threshold distance 405 from a geographic area that previously was a network weak spot. The network entity 105-g may be a natural serving cell for this geographic area and may provide more reliable service, improve signal strength, improved signal quality, improved throughput, reduced connection failures, or any combination thereof for the geographic area (as compared to the network entity 105-e). Accordingly, switching the serving cell from the network entity 105-e to the network entity 105-g may resolve the network weak spot for UEs 115, such as the UE 115-c.

In some implementations, the service or platform may perform a cell configuration change SINR assessment for the wireless network 400. The cell configuration change SINR assessment may indicate a new throughput for impacted cells after the cell configuration change. For each cell configuration change, the service or platform may calculate (such as determine, estimate, or otherwise ascertain) a change to an impacted tile (such as in dBs, assuming a cell antenna pattern) as described in more detail below. The service or platform may calculate new SINR values in accordance with an update to any parameter that impacts a cell footprint (such as a power distribution, in dBm, per tile in space (according to x, y, and z coordinates)), such as an antenna configuration parameter, an A5 measurement event, a B1 measurement event, a B2 measurement event, or any other parameter or event. For example, the service or platform may calculate new SINR values in accordance with an update to an antenna pattern angle of direction for a tile. Equation 1 indicates a SINR calculation prior to the update. If an impacted tile has a new serving cell or any change to a signal power for its serving cell in accordance with the cell configuration change (such as for the serving cell or an interferer), the service or platform may calculate (such as determine, estimate, or otherwise ascertain) the SINR for the tile after the update according to Equation 2.

$$SINR before = \frac{{Signal}_{Power}}{( {Interf}_{{1}_{power}} + {Interf}_{{2}_{power}} + … + {Interf}_{{100}_{power}} + Noise )} \qquad ( 1 )$$

$$SINR after = \frac{{Signal}_{NEW Power}}{( {Interf}_{{1}_{power}} + {Interf}_{{2}_{power}} + … + {Interf}_{{20}_{power}} + Noise )} \qquad ( 2 )$$

The Signal_{Power} value may be the previous signal power for the serving cell of the impacted tile before the cell configuration change, and the Signal_{NEW Power} value may be the new signal power for the serving cell of the impacted tile after the cell configuration change. The values Interf_{X}_{_{power}} may be the signal powers of the X interferers affecting the tile. The quantities of interferers affecting the tile before and after the cell configuration change may be any quantity (such as 100 and 20 as shown in Equations 1 and 2, or any other quantities). Equations 1 and 2 also may include a Noise value that may interfere with the serving cell.

If an impacted tile has a new interferer in accordance with the cell configuration change, the service or platform may calculate (such as determine, estimate, or otherwise ascertain) the SINR before the change for the tile according to Equation 1 and the SINR after the change for the tile according to Equation 3.

$$SINR after = \frac{{Signal}_{Power}}{( {Interf}_{{1}_{power}} + {Interf}_{{2}_{power}} + … + {Interf}_{{20}_{power}} + Noise )} \qquad ( 3 )$$

The value Inter f_{X}_{_{NEW power}} may be the new signal power of the X^{th} interferer affecting the tile after the cell configuration change. This may be a new interferer or an updated signal power for an existing interferer affecting the tile. The service or platform may calculate (such as determine, estimate, or otherwise ascertain) the SINR change for each impacted tile with an updated serving cell or interferer.

In some implementations, the service or platform may determine (such as calculate, estimate, predict, or otherwise ascertain) an amount of usage per impacted tile. The amount of usage may be a quantity of UEs (or users) per tile, a volume of traffic for the tile, or some combination thereof. The service or platform may calculate (such as determine, estimate, or otherwise ascertain) an overall user impact of a SINR change for a time period in accordance with the amount of usage per impacted tile. In some implementations, the service or platform may calculate (such as determine, estimate, or otherwise ascertain) a new throughput in accordance with the Shannon-Hartley formula and a SINR value after the cell configuration change in accordance with Equation 1 or 3. For example, the service or platform may use Equation 4 or any other throughput calculation to calculate (such as determine, estimate, or otherwise ascertain) a throughput, TP, for an impacted tile at a bandwidth BW after the cell configuration change.

$$TP = BW * {log}_{2} ( 1 + SINR after ) \qquad ( 4 )$$

In some implementations, the service or platform may use Equation 5 to calculate (such as determine, estimate, or otherwise ascertain) the throughput after the cell configuration change, TP after, as a function of the throughput before the cell configuration change, TP before, and a SINR ratio.

$$TP after = SINR after / SINR before * TP before \qquad ( 5 )$$

Additionally, or alternatively, the service or platform may use Equations 6 and 7 to calculate (such as determine, estimate, or otherwise ascertain) a throughput improvement rate and the throughput after the cell configuration change.

$${TP}_{Improvement Rate} = \frac{{log}_{2} ( 1 + SINR after )}{{log}_{2} ( 1 + SINR before )} \qquad ( 6 )$$

$$TP after = {TP}_{Improvement Rate} \times TP before \qquad ( 7 )$$

The service or platform may calculate (such as determine, estimate, or otherwise ascertain) an overall user impact in terms of throughput according to the quantity of users per impacted tile, Q Users, and the throughput, TP, per impacted tile for a total quantity of N impacted tiles in accordance with Equation 8.

$$User Impact = \frac{\begin{matrix}Q {Users}_{Tile 1} * {TP}_{Tile 1} + Q {Users}_{Tile 2} * \\ {TP}_{Tile 2} + … + Q {Users}_{Tile N} * {TP}_{Tile N}\end{matrix}}{( Total Quantity of Users )} \qquad ( 8 )$$

Additionally, or alternatively, the service or platform may use a traffic volume for the tiles, an average traffic volume for a cell, an average quantity of users for a cell, or any combination of these or any other indicator that represents a volume of users or traffic per tile to estimate the quantity of users per impacted tile. The service or platform may determine (such as select, or otherwise ascertain) to send an indication of a cell configuration change (such as one or more updates to antenna configuration parameters) to the wireless network 400 if the overall throughput or user impact (such as for a time period, such as a day, multiple days, an hour, a busiest hour) satisfies, or otherwise meets, a threshold improvement rate. In some implementations, the threshold improvement rate may be configured by an MNO for the wireless network 400.

In some implementations, the service or platform may use multiple thresholds for evaluating the cell configuration change. A first threshold may be an example of a quality indicator threshold that indicates an unacceptable radio condition (per service or in general across services). If the cell configuration change causes an area (such as a cell, a tile, a set of tiles) to have a radio condition (such as a SINR, a CQI, or another metric) that fails to satisfy the quality indicator threshold, the service or platform may determine not to perform the cell configuration change. For example, if the cell configuration change causes an area to experience a SINR value less than −3 dB, the service or platform may reject the cell configuration change. Such a cell configuration change may fail to resolve the network weak spot or may simply relocate the network weak spot to a different area. A cell configuration change that improves an overall distribution of the network weak spot may, in some implementations, satisfy this first threshold.

A second threshold may be an example of an overall distribution threshold (such as SINR distribution or throughput distribution). For example, a cell configuration change may improve a network weak spot, but may degrade SINR metrics, throughput, or other radio conditions throughout other areas (for example, cells, tiles). The second threshold may ensure that the degradation across the system does not exceed a specific amount. For example, if the cell configuration change resolves the network weak spot but causes significant degradation across the system, the service or platform may reject the cell configuration change.

In some implementations, the service or platform may determine (such as estimate, calculate, or otherwise ascertain) how the traffic is experienced by users (for example, UEs 115) in accordance with (such as in response to) the cell configuration change. For example, the cell configuration change may affect the traffic across one or more tiles. The service or platform may calculate, per tile (or other unit of measurement, such as per user), if one or more radio conditions improve in accordance with the cell configuration change. In calculating the changes to radio conditions, the service or platform may ignore areas that do not experience traffic (or experience negligible traffic). In some implementations, the service or platform may weight the changes to the radio conditions according to an amount of traffic. For example, the service or platform may weight the calculations for areas with relatively more traffic more heavily than areas with relatively less traffic. The service or platform may evaluate the cell configuration change according to the weighted change in radio conditions for tiles, users (such as UEs 115), or both.

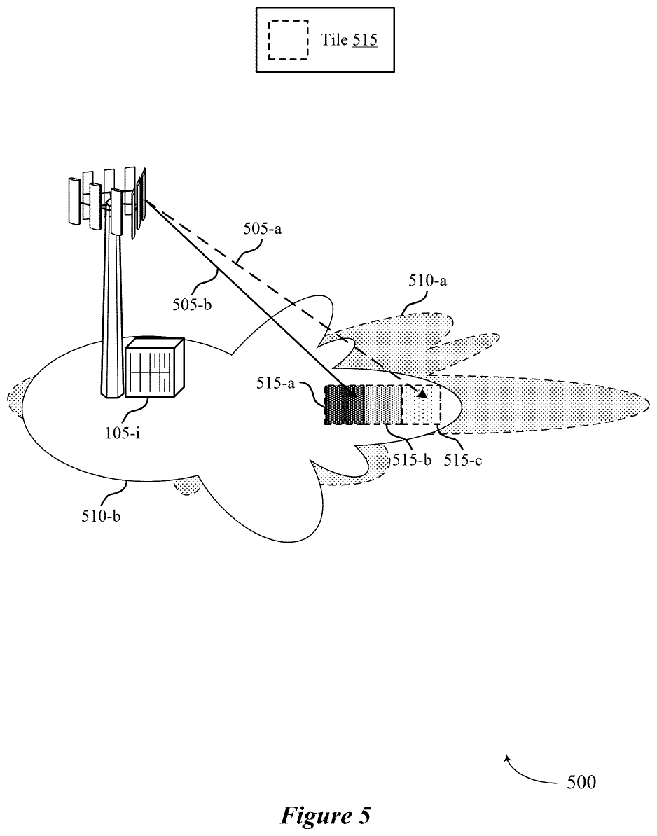

FIG. 5 shows an example of an antenna configuration update 500 that supports resolving network weak spots. A network entity 105-i, which may be an example of a network entity 105 as described with reference to FIGS. 1-4, may perform the antenna configuration update 500. In some implementations, a service or platform, such as an SMO or rApp, may send a request for an update to a parameter (such as an antenna configuration parameter or any other parameter affecting a cell footprint) for the network entity 105-i to a wireless network that includes the network entity 105-i. For example, the service or platform may send the request to an operator of the wireless network, to a core network of the wireless network, to the network entity 105-i of the wireless network, or any combination thereof. The network entity 105-i may receive a signal that indicates the update to the parameter and, in some implementations, may update an antenna configuration or other configuration at the network entity 105-i in accordance with the update to the parameter.

In some implementations, the network entity 105-i may be an example of an interferer at a network weak spot. In some such implementations, the update to the parameter (such as an update to an antenna configuration parameter) may include a down-tilt for the antenna configuration at the network entity 105-i. For example, the network entity 105-i may include a set of antennas (such as an antenna panel, a set of antenna ports) with an angle of transmission 505-a. The network entity 105-i may decrease (such as down-tilt) the angle of transmission for the set of antennas from the angle of transmission 505-a to the angle of transmission 505-b in accordance with the update to the antenna configuration parameter. Alternatively, in some implementations, the network entity 105-i may be an example of a natural serving cell at a network weak spot. In some such implementations, the update to the antenna configuration parameter may include an up-tilt for the antenna configuration at the network entity 105-i. For example, the network entity 105-i may increase (such as up-tilt) the angle of transmission for the set of antennas from the angle of transmission 505-b to the angle of transmission 505-a in accordance with the update to the antenna configuration parameter. Additionally, or alternatively, the update to the parameter may update any other parameters for an interferer or a natural serving cell, such as a transmit power, an antenna profile, an antenna azimuth, an antenna port configuration, or any combination of these or any other parameters that impact a cell footprint of the network entity 105-i.

In some implementations, the service or platform (such as the SMO or rApp) may perform an antenna profile geometrical calculation. For example, the service or platform may calculate (such as determine, identify, select, track, estimate, predict, or otherwise ascertain) a signal strength map for the network entity 105-i or for a set of network entities 105 including the network entity 105-i. In some implementations, the signal strength map may be an example of a multi-dimensional (such as three-dimensional (3D)) signal strength map according to an RF network model. The signal strength map or the RF network model, or both, may be representative of the network prior to a change, such as prior to an antenna configuration update or any other network change that impacts an SINR, an RSRP, or a traffic load, among other examples. For example, the multi-dimensional signal strength map may measure RSRP or SINR values at different coordinates in accordance with the current network parameters. In some implementations, the map may indicate RSRP values, SINR values, or both per tile for servers and interferers. The service or platform may determine (such as generate) the map using data (such as DMAP data, crowd-sourced data, trace data, MDT data, probe data, or any combination thereof), an RF network model (such as a digital twin), or both. That is, a current network configuration may include DMAP data, trace data, or other data sources indicative of one or more SINRs, one or more RSRPs, or one or more other performance metrics for each of one or more tiles, may include ray trace prediction using an RF network model (such as a digital twin) indicative of one or more SINRs, one or more RSRPs, or one or more other performance metrics for one or more tiles for which other data (such as DMAP data) is not available or sufficient, or a hybrid of data sources and ray trace prediction. A digital twin may be an example of a dynamic, virtual representation of the wireless communication network (or a portion of the wireless communication network). The digital twin may support calculation of RSRP values, SINR values, or both in accordance with digital map data (such as clutter, terrain, foliage, or other physical features), physical attributes for wireless devices (such as from a planning tool, including antenna height, type, azimuth, or other attributes), configuration data (such as communication configuration data, including frequency, power, or other metrics), or any combination thereof. In some implementations, the service or platform may combine DMAP data with a Ray Trace model prediction using the digital twin to determine (such as calculate, predict, or otherwise ascertain) the RSRP values, SINR values, or both per tile. For example, if the DMAP data fails to provide sufficient information for a specific area, the service or platform may use the Ray Trace model to predict information for the area, effectively creating a complete map for the wireless network. The service or platform may determine (such as calculate, estimate, predict, or otherwise ascertain) a first signal strength map 510-a associated with the current antenna configuration at the network entity 105-i and may determine (such as calculate, estimate, predict, or otherwise ascertain) a second signal strength map 510-b associated with the updated antenna configuration at the network entity 105-i. In some implementations, the service or platform may determine the second signal strength map 510-b after the update according to geometrical calculations, a Ray Trace model prediction using the digital twin, or a combination thereof.

The service or platform may additionally, or alternatively, calculate (such as determine, identify, select, track, estimate, predict, or otherwise ascertain) an impact of the antenna configuration update 500 on one or more tiles 515. A tile 515 may be an example of a unit of area within the wireless network. The tiles 515 may segment the coverage area of the wireless network to track granular information about the wireless network. For example, the service or platform may calculate (such as determine, identify, select, track, estimate, predict, or otherwise ascertain) how switching from the first angle of transmission 505-a to the second angle of transmission 505-b affects average signal strength (such as in dBs, in dBms) at the tiles 515. In some implementations, the service or platform may calculate (such as determine, identify, select, track, estimate, predict, or otherwise ascertain) the impact of the antenna configuration update 500 on one or more vertical tiles, one or more horizontal tiles, or some combination thereof. For example, switching from the first angle of transmission 505-a to the second angle of transmission 505-b may increase an average signal strength at tile 515-a, relatively maintain an average signal strength at tile 515-b, and decrease an average signal strength at tile 515-c. Such an antenna configuration update 500 may reduce the ability of the network entity 105-i to over-shoot coverage, reducing the likelihood that the network entity 105-i operates as an interferer for a network weak spot. Other parameter changes (such as configuration changes) may affect the tiles differently in accordance with the antenna pattern for the network entity 105-i.

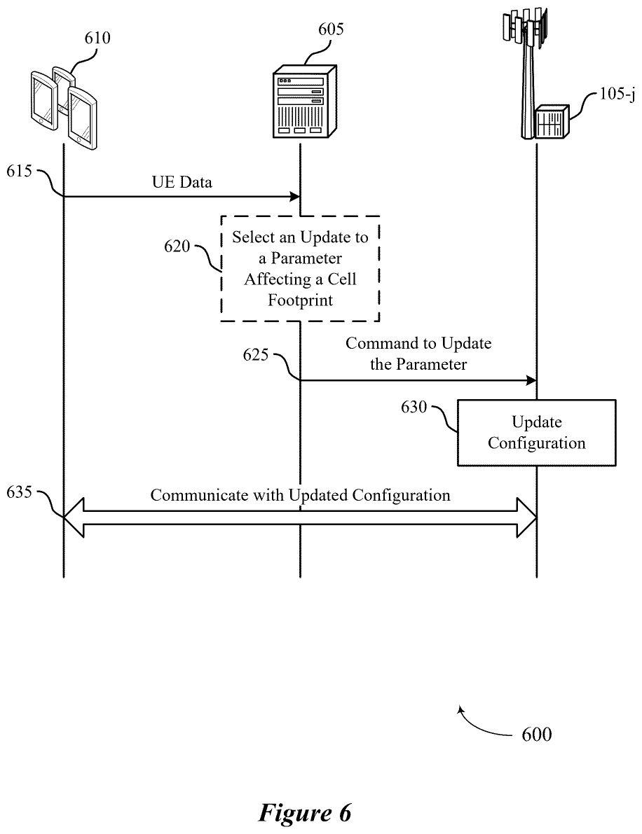

FIG. 6 shows an example of a process flow 600 that supports resolving network weak spots according to UE data. Some aspects of the process flow 600 may be performed by aspects of the wireless communications system 100, such as a UE 115 or a network entity 105 as described with reference to FIG. 1. A device 605 supporting a service or platform, such as a DMAP, an SMO, an rApp, an automation suite application, or any combination thereof, may perform other aspects of the process flow 600. The device 605 may be an example of a processing device or system, such as a server, worker, server cluster, cloud-based server, database server, computing device, user device, UE 115, network entity 105, or any combination thereof. In the following description of the process flow 600, some operations may be omitted from the process flow 600, and some other operations may be added to the process flow 600. Further, although some operations or signaling may be shown to occur at different times for discussion purposes, these operations may occur at the same time.

At 615, the device 605 may receive data (such as UE data) associated with a set of UEs 610. The set of UEs 610 may include multiple UEs 115 as described with reference to FIGS. 1-4. Additionally, or alternatively, the data may include Ray Trace prediction data in accordance with a digital twin. The device 605 may aggregate the UE data from the set of UEs 610 and store the UE data at the device 605 or another database. The UE data may include any device-level data, such as DMAP data, trace data, MDT data, probe data, and crowd-sourced data, among other examples. In some implementations, the device 605 may receive the UE data directly from the set of UEs 610. In some other implementations, the device 605 may receive the UE data via one or more network entities 105 (such as network entities 105 of a wireless network that serves the set of UEs 610) or via one or more other functions or components that collect DMAP (or other device-level) data. In some implementations, a DMAP may perform at least a portion of the data collection, data storage, or both.

At 620, the device 605 may select an update to a parameter for a network entity 105-j in accordance with the data. The parameter may be any parameter that affects the cell footprint of the network entity 105-j. In some implementations, the device 605 may select one or more updates to one or more parameters for one or more network entities 105 in accordance with an AI model. For example, the data may indicate a geographic area of the wireless network that does not meet, or otherwise fails to satisfy, a threshold value of a signal quality, a signal strength, a signal throughput, a connection success rate, a setup success rate, or any combination thereof. In some implementations, the AI model may propose (such as determine, predict, or otherwise output) a network configuration change solution for any relatively poor experience for one or more users (such as one or more UEs 115). The threshold value may correspond to the wireless network (such as a network threshold), a service provided by the wireless network (such as a service threshold), or both. For example, a quantity of RLFs associated with the geographic area may be greater than a threshold quantity of RLFs (such as an average of one RLF event per second or some other RLF threshold), a quantity of RACH failures associated with the geographic area may be greater than a threshold quantity of RACH failures (such as an average of one RACH failure event per second or some other RACH failure threshold), one or more RSRP measurements associated with the geographic area may be less than a threshold RSRP value (such as any absolute or relative RSRP threshold), one or more throughput measurements associated with the geographic area may be less than a threshold throughput value (such as 10 Megabits per second (Mbps) or some other throughput threshold), one or more SINR measurements associated with the geographic area may be less than a threshold SINR value (such as −5 dB or some other SINR threshold), or any combination thereof. The geographic area may be an example of a network weak spot. In some implementations, an SMO, rApp, or automation suite application may perform at least a portion of the update selection.

At 625, the device 605 may output a command that indicates the update to the parameter for the network entity 105-j. In some implementations, the device 605 may send a request to perform the update to the parameter to the wireless network including the network entity 105-j. The wireless network may send the request to perform the update to the parameter to the network entity 105-j. In some implementations, the command may be an example of a provisioning command for an eNB, gNB, or other network entity to change the parameter. In some implementations, the device 605 may update the parameter in an EMS for the network entity 105-j. Updating the parameter in the EMS may trigger the EMS or some other service or platform to output the command to correspondingly update the parameter at the network entity 105-j, such that the wireless network and the EMS maintain synchronicity. In some other implementations, the device 605, such as a device running an SMO, rApp, automation suite application, or other management application, may update the parameter at the network entity 105-j.

At 630, the network entity 105-j may update a configuration (such as an antenna configuration for a set of antennas) in accordance with the update to the parameter. For example, the network entity 105-j may update a physical antenna configuration, an antenna port configuration, or both for the set of antennas. In some implementations, updating the antenna configuration may involve the network entity 105-j updating an angle of transmission for the set of antennas. For example, if the network entity 105-j is an interferer (such as is outside a threshold distance from the geographic area corresponding to the network weak spot), the network entity 105-j may decrease (such as down-tilt) the angle of transmission for the set of antennas. Down-tilting the angle of transmission may cause the network entity 105-j to remove one or more connections with one or more UEs 115 (such as from the set of UEs 610) located within the geographic area corresponding to the network weak spot. Alternatively, if the network entity 105-j is a natural serving cell (such as is within a threshold distance from the geographic area corresponding to the network weak spot), the network entity 105-j may increase (such as up-tilt) the angle of transmission for the set of antennas. Up-tilting the angle of transmission may cause the network entity 105-j to establish one or more connections with one or more UEs 115 (such as from the set of UEs 610) located within the geographic area corresponding to the network weak spot. If the network entity 105-j is an interferer compensator, the network entity 105-j may increase (such as up-tilt) the angle of transmission for the set of antennas in accordance with another network entity 105 (such as an interferer) decreasing an angle of transmission. The interferer compensator may up-tilt the angle of transmission to mitigate potential decreases in network coverage according to the interferer down-tilting an angle of transmission. Additionally, or alternatively, the network entity 105-j may update other parameters, such as a transmit power, an antenna profile, an antenna azimuth, an antenna port configuration, a parameter associated with an A5 measurement event, a parameter associated with a B1 measurement event, a parameter associated with a B2 measurement event, or any combination thereof in accordance with the update to the parameter.

At 635, the network entity 105-j may communicate in accordance with the updated configuration. For example, the network entity 105-j may communicate in accordance with the updated angle of transmission for the set of antennas. In some implementations, the network entity 105-j may communicate with one or more UEs 115 of the set of UEs 610. If the network entity 105-j was an interferer for the network weak spot, the network entity 105-j may refrain from communicating with UEs 115 operating within the geographic area of the network weak spot in accordance with the updated configuration. If the network entity 105-j was a natural serving cell for the network weak spot, the network entity 105-j may communicate with UEs 115 operating within the geographic area of the network weak spot in accordance with the updated configuration. The updated configuration may improve user experience in the network weak spot, effectively mitigating, removing, or otherwise improving the network weak spot for the wireless network.

Certain aspects and techniques as described herein may be implemented, at least in part, using an AI program, such as a program that includes an ML or artificial neural network (ANN) model. An example ML model may include mathematical representations or define computing capabilities for making inferences from input data according to patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model. An example ML model operating on input data may start at an initial output according to the biases and update its output according to a combination of the input data and the weights.

In some aspects, an ML model may be configured to provide computing capabilities for wireless communications. Such an ML model may be configured with weights and biases to improve network coverage, for example, by adjusting (or requesting adjustments to) antenna configuration parameters at one or more network entities 105 to mitigate, or otherwise remove, network weak spots. The ML model may support location-based automation in accordance with cell telemetry. During operation of a device, the ML model may receive input data such as UE data, DMAP data, trace data, MDT data, probe data, crowd-sourced data, network data, or some combination thereof associated with geographic information. The ML model may make inferences such as recommended or suggested updates to one or more antenna configuration parameters for one or more network entities 105 in accordance with the weights and biases.

ML models may be deployed in one or more devices (such as network entities 105, UEs 115, or devices supporting a service or platform, such as a DMAP, SMO, rApp, automation suite application, or any combination thereof) and may be configured to enhance various aspects of a wireless communications system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization channel state estimation, channel equalization, channel state feedback, modulation, demodulation, device positioning, beamforming, load balancing, operations and management functions, security, antenna configurations, or any combination thereof.

ML models may be characterized in terms of types of learning that generate specific types of learned models that perform specific types of tasks. For example, different types of ML include supervised learning, unsupervised learning, semi-supervised learning, reinforcement learning, among other examples. ML models may be used to perform different tasks such as classification or regression, where classification refers to determining one or more discrete output values from a set of predefined output values, and regression refers to determining continuous values which are not bounded by predefined output values. For example, a classification ML model may produce an output which includes a selection (such as determination, identification, recommendation) of network entities affecting a network weak spot, such as one or more interferers, one or more natural serving cells, one or more interferer compensators, or any combination thereof. A regression ML model may produce an output which includes a selection (such as determination, calculation, recommendation) of one or more updates to antenna configuration parameters, such as one or more updates to antenna angles, transmit powers, antenna profiles, antenna azimuths, antenna port configurations, or any combination thereof. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), among other examples.

In some aspects of this disclosure, a service or platform may implement a reinforcement learning AI model that uses a greedy approach to optimize, or otherwise improve, antenna configurations for a set of network entities 105 of a wireless network. The AI model may implement an AI optimizer engine or other component to select (such as determine, predict, estimate, or otherwise ascertain) one or more configurations, one or more parameter updates, or one or more configuration updates for one or more network entities 105 that satisfy, or otherwise meet, one or more conditions. In some implementations, the service or platform may configure the one or more conditions to adjust the AI optimization scheme. The one or more conditions may include improving signal metrics (such as RSRP, RSRQ, SINR, or throughput values) for a network weak spot to meet, or otherwise satisfy, a threshold signal metric. For example, the threshold signal metric may be an example of a minimum allowed SINR value configured for an operator or service. Additionally, or alternatively, the one or more conditions may include not creating any new coverage gaps within the wireless network (such as indicated by RSRP or other signal measurements for an operator or service). For example, a coverage gap may be a geographic area in which the RSRP metrics, or other similar metrics, fall below a threshold value. Additionally, or alternatively, the one or more conditions may include not creating any new network weak spots within the wireless network (such as geographic areas with average signal metrics below the threshold signal metric, such as SINR values below a SINR threshold for an operator or service). Additionally, or alternatively, the one or more conditions may include satisfying, or otherwise meeting, a threshold improvement rate for the wireless network. The threshold improvement rate may be associated with an overall SINR value for a set of impacted tiles, an overall throughput for the set of impacted tiles, or both for a time period, such as a day, multiple days, a specific hour (such as the hour with the most user traffic), or any combination thereof. In some implementations, a mobile network operator (MNO) may configure the threshold improvement rate for the wireless network. If the AI model selects (such as determines, identifies, calculates, or otherwise ascertains) updates to network parameters, such as antenna configuration parameters or other network parameters, that satisfy the one or more conditions, the service or platform hosting the AI model may send an indication of the updates to network parameters to the wireless network (such as to the MNO, to a core network, to one or more network entities 105) requesting that the wireless network perform the indicated updates. In some implementations, additional, or alternative, conditions may be configured for the AI optimization. In some implementations, the AI model may use, or indicate, cell-based updated, geographic-based triggers, handover statistics, timing advance metrics, physical resource block (PRB) utilization, or any combination thereof.

The description herein illustrates, by way of some examples, how one or more tasks or problems in wireless communications may benefit from the application of one or more ML models to improve network coverage, for example, by removing or mitigating network weak spots. To facilitate the discussion, an ML model configured using an ANN is used, but it should be understood, that other types of ML models may be used instead of an ANN. Hence, unless expressly recited, subject matter regarding an ML model is not necessarily intended to be limited to an ANN solution. Further, it should be understood that, unless otherwise specifically stated, terms such “AI/ML model,” “ML model,” “trained ML model,” “ANN,” “model,” “algorithm,” or the like are intended to be interchangeable.

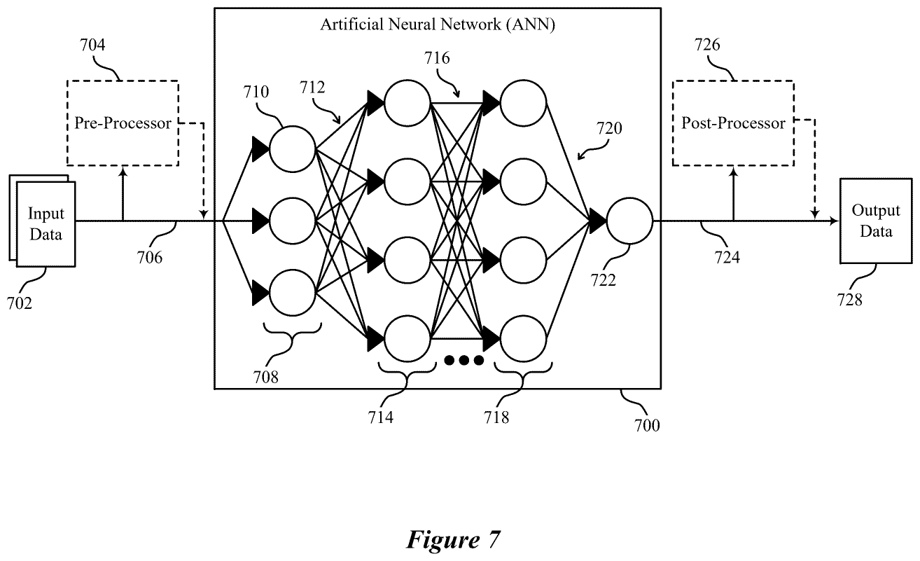

FIG. 7 is an illustrative block diagram of an example ML model represented by an ANN 700. The ANN 700 may receive input data 706 which may include one or more bits of data 702, pre-processed data output from a pre-processor 704, or some combination thereof. Here, data 702 may include training data, verification data, application-related data, or the like, according to, for example, the stage of deployment of the ANN 700. The pre-processor 704 may be included within the ANN 700 in some other implementations. The pre-processor 704 may, for example, process all or a portion of the data 702 which may result in some of the data 702 being changed, replaced, deleted, or otherwise modified. In some implementations, the pre-processor 704 may add additional data to the data 702. In some implementations, the pre-processor 704 may be an example of an ML model, such as another ANN. In some implementations, such as a service or platform (such as a DMAP) may collect the data 702 for training the ANN 700, running the ANN 700, or both. For example, the DMAP may collect and aggregate data 702 from multiple UEs 115 operating within a wireless network. The DMAP may label the data, create datasets, identify features, or perform any other operations to support the ANN 700.

The ANN 700 may include at least one first layer 708 of artificial neurons 710 to process input data 706 and provide resulting first layer data via connections or “edges” such as edges 712 to at least a portion of at least one second layer 714. The second layer 714 may process data received via the edges 712 and may provide second layer output data via edges 716 to at least a portion of at least one third layer 718. The third layer 718 may process data received via the edges 716 and may provide third layer output data via edges 720 to at least a portion of a final layer 722 including one or more artificial neurons 710 to provide output data 724. In some implementations, all or part of the output data 724 may be further processed in some manner by a post-processor 726. The ANN 700 may provide output data 728 that is in accordance with the output data 724, post-processed data output from the post-processor 726, or some combination thereof.

The post-processor 726 may be included within the ANN 700 in some other implementations. The post-processor 726 may, for example, process all or a portion of the output data 724 which may result in the output data 728 being different, at least in part, to the output data 724, as result of data being changed, replaced, deleted, or otherwise modified. In some implementations, the post-processor 726 may be configured to add additional data to the output data 724. The second layer 714 and the third layer 718 may represent intermediate or hidden layers that may be arranged in a hierarchical or other like structure. Although not explicitly shown, there may be one or more further intermediate layers between the second layer 714 and the third layer 718. In some implementations, the post-processor 726 may be an ML model, such as another ANN.

The structure and training of artificial neurons 710 in the various layers may be tailored to specific rules or conditions of an application. Within a given layer such as the first layer 708, the second layer 714, or the third layer 718 of the ANN 700, some or all of the artificial neurons 710 may be configured to process information provided to the layer and output corresponding transformed information from the layer. For example, transformed information from a layer may represent a weighted sum of the input information associated with or otherwise in accordance with a non-linear activation function or other activation function used to “activate” artificial neurons of a next layer. Artificial neurons in such a layer may be activated by or be responsive to parameters such as the previously described weights and biases of the ANN 700. The weights and biases of the ANN 700 may be adjusted during a training process or during operation of the ANN 700. The weights of the various artificial neurons 710 may control a strength of connections between layers or artificial neurons 710, while the biases may control a direction of connections between the layers or artificial neurons 710. An activation function may select (such as determine or otherwise ascertain) whether an artificial neuron 710 transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 706. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as the ANN 700, may be conducted using training data. Training data may include one or more datasets which the ANN 700 may use to identify patterns or relationships. Training data may represent various types of information, including written, visual, audio, environmental context, operational properties, or other data. During training, the parameters (such as the weights and biases) of the artificial neurons 710 may be changed, such as to minimize or otherwise reduce a loss function or a cost function. A training process may be repeated multiple times to fine-tune the ANN 700 with each iteration.

The ANN 700 or other ML models may be implemented in various types of processing circuits along with memory and applicable instructions therein. For example, general-purpose hardware circuits, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like also may be employed. In some implementations, the ML model may be implemented by an NPU or a TPU embedded in a system-on-a-chip (SoC) along with other components, such as one or more CPUs, GPUs, or the like. An SoC may include several components manufactured on a shared semiconductor substrate. The NPU or TPU may be controlled by the one or more CPUs by configuring the ML model implemented by the NPU or TPU with weights and biases, providing certain training data to the ML model to configure the ML model, or providing input data to the ML model to obtain related inferences. The one or more CPUs also may receive the inferences and be configured to perform certain actions according to the inferences produced by the ML model. The actions performed by the one or more CPUs may include sending commands to other components of the SoC or components external to the SoC to perform certain actions. For example, the CPU may send commands to a transceiver in accordance with the outputs or inferences obtained from an ML model to cause the transceiver to operate on a wireless network in accordance with the ML model.

In some implementations, one or more devices or services may support processes relating to an ML model's usage, maintenance, activation, reporting, or the like. In some implementations, all or part of a dataset or model may be shared across multiple devices, to provide or otherwise augment or improve processing. In some implementations, signaling mechanisms may be utilized at various nodes of a wireless network to signal the capabilities for performing specific functions related to the ML model, support for specific ML models, capabilities for gathering, creating, transmitting training data, or other ML related capabilities. ML models in wireless communications systems may, for example, be employed to support decisions or improve performance relating to wireless resource allocation or selection, wireless channel condition estimation, interference mitigation, beam management, positioning accuracy, energy savings, modulation or coding schemes, or any combination of these or other network parameters. In some implementations, model deployment may occur jointly or separately at various network levels, such as, a UE 115, a network entity 105 such as a base station, a disaggregated network entity 105 such as a CU, DU, or RU, a device supporting a service or platform for data management and analytics, or any combination thereof.

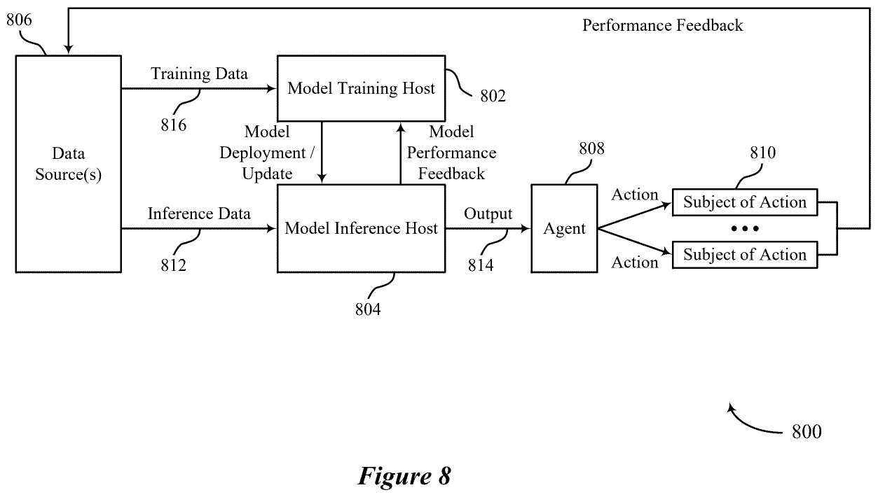

FIG. 8 is an illustrative block diagram of an example ML architecture 800 that may be used for wireless communications. As illustrated, the ML architecture 800 may include multiple logical entities, such as a model training host 802, a model inference host 804, one or more data sources 806, and an agent 808. The model inference host 804 is configured to run an ML model in accordance with inference data 812 provided by the one or more data sources 806. The model inference host 804 may produce output 814, which may include a prediction or inference, such as a discrete or continuous value in accordance with the inference data 812, which may be provided as an input to the agent 808.

The agent 808 may represent an element or an entity of a wireless communications system including, for example, a RAN, a wireless local area network, a D2D communications system, or any other system. As an example, the agent 808 may be a network entity 105, such as a network entity 105 described with reference to FIGS. 1-6. In some implementations, the network entity 105 may be a CU, a DU, or an RU. Additionally, or alternatively, the agent 808 also may be a type of agent that depends on the type of tasks performed by the model inference host 804, the type of inference data 812 provided to the model inference host 804, or the type of output 814 produced by the model inference host 804.

The agent 808 may perform one or more actions associated with receiving the output 814 from the model inference host 804. For example, if the agent 808 is, or represents, a device associated with a service or platform or a network entity 105, and the output from the model inference host 804 is associated with a network weak spot, an antenna configuration update, or both, the agent 808 may determine whether to change or modify an antenna configuration according to the output 814. The agent 808 may indicate the one or more actions performed to at least one subject of an action 810. For example, if the agent 808 determines to change or modify an antenna configuration for a network entity 105, the agent 808 may send a signal requesting an update to an antenna configuration to the subject of the action 810 (such as the network entity 105). In some implementations, the agent 808 and the subject of the action 810 may be the same entity.

Data can be collected from data sources 806 and may be used as training data 816 for training an ML model or as inference data 812 for feeding an ML model inference operation. The data sources 806 may collect data from various subject of the actions 810 (such as network entities 105) or other entities (such as UEs 115 operating within a wireless network) and may provide the collected data to a model training host 802 for ML model training. In some implementations, a DMAP system or another data management platform may collect the data from multiple UEs 115. The DMAP system or another system, such as an SMO or rApp, may determine (or otherwise select) network weak spots according to user experiences of the UEs 115. In some implementations, if the output 814 provided to the agent 808 is inaccurate (or the accuracy is below an accuracy threshold), the model training host 802 may provide feedback to the model inference host 804 to modify or retrain the ML model used by the model inference host 804, such as via an ML model deployment update.

The model training host 802 may be deployed at the same or a different entity than that in which the model inference host 804 is deployed. For example, in order to offload model training processing, which can impact the performance of the model inference host 804, the model training host 802 may be deployed at a model server or other processing device or system.

In some implementations, an ML model is deployed at or on a device supporting a service or platform for data management and analytics. For example, the DMAP system, SMO, or rApp may include one or more devices that train and run the ML model. The DMAP system, SMO, or rApp may send results (such as outputs 814) of the ML model to a wireless network to update one or more network entities 105 according to the results of the ML model.

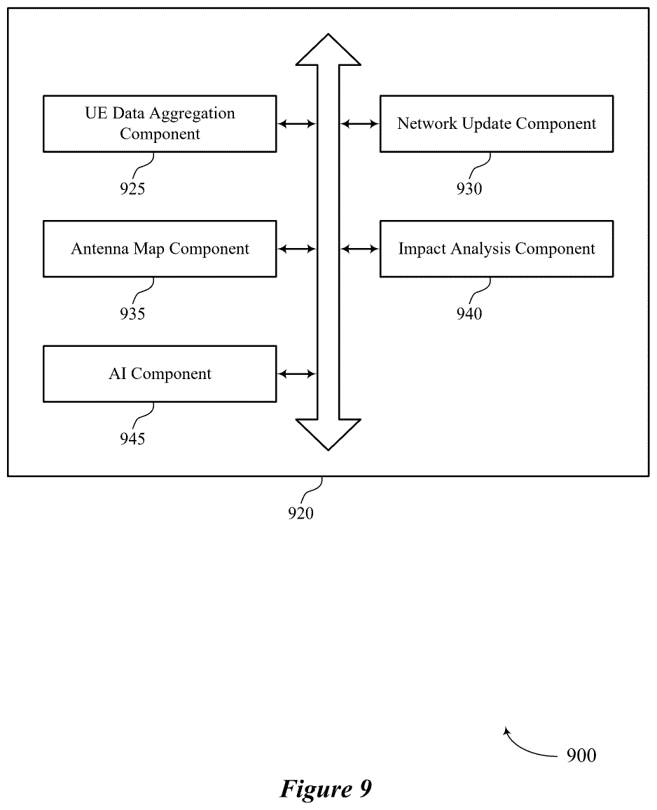

FIG. 9 shows a block diagram 900 of an example device 920 that supports resolving network weak spots according to UE data. The device 920 may be an example of aspects of a processing device or system associated with a platform or service that supports data management and analytics, such as a DMAP, an SMO, an rApp, or any combination thereof. For example, the device 920 may be an example of a device 605 as described with reference to FIG. 6. The device 920, or various components thereof, may be an example of means for performing various aspects of resolving network weak spots according to UE data as described herein. For example, the device 920 may include a UE data aggregation component 925, a network update component 930, an antenna map component 935, an impact analysis component 940, an AI component 945, or any combination thereof. Each of these components, or components or subcomponents thereof (such as one or more processors, one or more memories, or both), may communicate, directly or indirectly, with one another (such as via one or more buses).

In some implementations, the device 920 may be an example or a component of an apparatus. The apparatus may include a processing system that includes processor circuitry and memory circuitry that stores code, the processing system configured to cause the apparatus to perform one or more functions as described herein. The UE data aggregation component 925 is configurable or configured to receive data associated with a set of multiple UEs served by a wireless network, the data indicating a geographic area of the wireless network that does not meet a threshold value of a signal quality, a signal strength, a signal throughput, a connection success rate, a setup success rate, or any combination thereof. The network update component 930 is configurable or configured to output a command that indicates an update to an antenna configuration parameter for a network entity of the wireless network in accordance with the data, where the update to the antenna configuration parameter for the network entity increases network coverage of the geographic area of the wireless network to meet the threshold value.

In some implementations, the antenna map component 935 is configurable or configured to select the update to the antenna configuration parameter for the network entity in accordance with a multi-dimensional signal strength map for the wireless network, the data associated with the set of multiple UEs providing information that defines the multi-dimensional signal strength map.

In some implementations, the impact analysis component 940 is configurable or configured to select a set of multiple impacted tiles, a set of multiple impacted cells, or both in accordance with the network entity being a service provider or an interferer for each impacted tile of the set of multiple impacted tiles, each impacted cell of the set of multiple impacted cells, or both. An updated measurement of the signal quality, the signal strength, the signal throughput, the connection success rate, the setup success rate, or any combination thereof may be calculated for the set of multiple impacted tiles, the set of multiple impacted cells, or both in accordance with the update to the antenna configuration parameter for the network entity. In some implementations, the data associated with the set of multiple UEs further indicates a quantity of UEs, a volume of traffic, or both for the set of multiple impacted tiles, the set of multiple impacted cells, or both. In some implementations, the updated measurement is weighted in accordance with the quantity of UEs, the volume of traffic, or both for the set of multiple impacted tiles, the set of multiple impacted cells, or both.

In some implementations, the AI component 945 is configurable or configured to select a set of multiple updates to a set of multiple antenna configuration parameters for a set of multiple network entities of the wireless network in accordance with an AI model, where the set of multiple updates to the set of multiple antenna configuration parameters includes the update to the antenna configuration parameter.

In some implementations, to support outputting the command, the network update component 930 is configurable or configured to output the command in accordance with the geographic area of the wireless network meeting the threshold value, an improvement to the signal quality, the signal strength, the signal throughput, the connection success rate, the setup success rate, or any combination thereof for the wireless network, an absence of additional geographic areas of the wireless network not meeting the threshold value, or any combination thereof according to the set of multiple updates to the set of multiple antenna configuration parameters for the set of multiple network entities.

In some implementations, the geographic area of the wireless network does not meet the threshold value in accordance with a quantity of RLFs associated with the geographic area being greater than a threshold quantity of RLFs, a quantity of RACH failures associated with the geographic area being greater than a threshold quantity of RACH failures, one or more RSRP measurements associated with the geographic area being less than a threshold RSRP value, one or more throughput measurements associated with the geographic area being less than a threshold throughput value, or any combination thereof.

In some implementations, the network entity is outside a threshold distance from the geographic area of the wireless network. In some such implementations, the update to the antenna configuration parameter for the network entity decreases coverage by the network entity of at least a portion of the geographic area of the wireless network. In some such implementations, the update to the antenna configuration parameter for the network entity includes a decrease to an angle of transmission for a set of antennas of the network entity.

In some other implementations, the network entity is within a threshold distance from the geographic area of the wireless network. In some such implementations, the update to the antenna configuration parameter for the network entity increases coverage by the network entity of at least a portion of the geographic area of the wireless network. In some such implementations, the update to the antenna configuration parameter for the network entity includes an increase to an angle of transmission for a set of antennas of the network entity.

In some implementations, the signal command indicates a second update to a second antenna configuration parameter for a second network entity of the wireless network in accordance with the update to the antenna configuration parameter for the network entity.

In some implementations, the antenna configuration parameter includes an angle of transmission, a transmit power, an antenna profile, an antenna azimuth, an antenna port configuration, or any combination thereof. In some implementations, the command further indicates a second update to an additional parameter that affects a coverage area for which the network entity provides active coverage. In some implementations, the additional parameter is associated with an A5 measurement event, a B1 measurement event, a B2 measurement event, or any combination thereof. In some implementations, the threshold value corresponds to the wireless network, a service provided by the wireless network, or both.

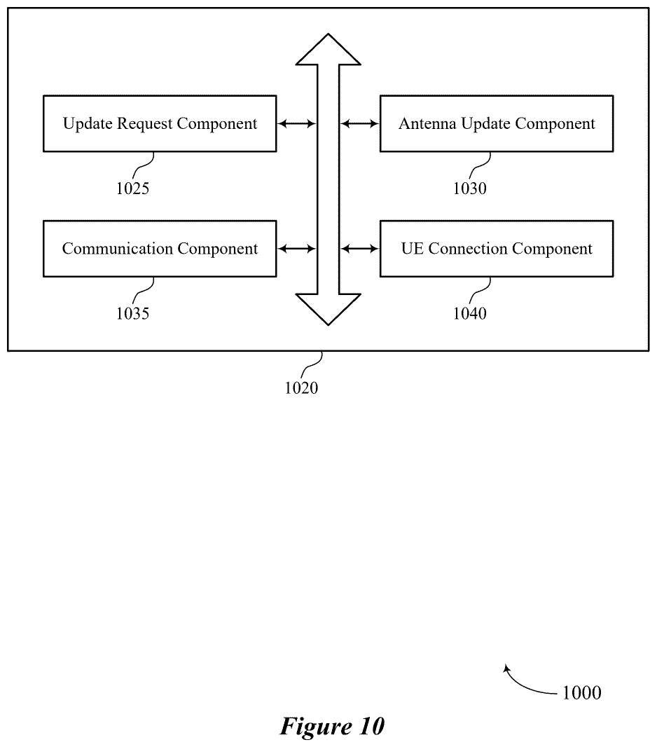

FIG. 10 shows a block diagram 1000 of an example network entity 1020 that supports resolving network weak spots according to UE data. The network entity 1020 may be an example of aspects of a network entity 105 as described with reference to FIGS. 1-6. The network entity 1020, or various components thereof, may be an example of means for performing various aspects of resolving network weak spots according to UE data as described herein. For example, the network entity 1020 may include an update request component 1025, an antenna update component 1030, a communication component 1035, a UE connection component 1040, or any combination thereof. Each of these components, or components or subcomponents thereof (such as one or more processors, one or more memories, or a combination thereof), may communicate, directly or indirectly, with one another (such as via one or more buses). The communications may include communications within a protocol layer of a protocol stack, communications associated with a logical channel of a protocol stack (such as between protocol layers of a protocol stack, within a device, component, or virtualized component associated with a network entity 105, between devices, components, or virtualized components associated with a network entity 105), or any combination thereof.

In some implementations, the network entity 1020 may support wireless communications. The network entity 1020 may include a processing system that includes processor circuitry and memory circuitry that stores code, the processing system configured to cause the network entity 1020 to perform one or more functions as described herein. The update request component 1025 is configurable or configured to obtain a command that indicates an update to an antenna configuration parameter for the network entity, the update to the antenna configuration parameter in accordance with a geographic area of the wireless network that does not meet a threshold value of a signal quality, a signal strength, a signal throughput, a connection success rate, a setup success rate, or any combination thereof. The antenna update component 1030 is configurable or configured to update an angle of transmission for a set of antennas of the network entity in accordance with the update to the antenna configuration parameter. The communication component 1035 is configurable or configured to communicate in accordance with the updated angle of transmission for the set of antennas.

In some implementations, the antenna update component 1030 is configurable or configured to update a physical antenna configuration, an antenna port configuration, or both for the set of antennas in accordance with the update to the antenna configuration parameter.

In some implementations, the network entity is outside a threshold distance from the geographic area of the wireless network. In some such implementations, the UE connection component 1040 is configurable or configured to remove a connection with a UE located within the geographic area of the wireless network in accordance with the updated angle of transmission for the set of antennas. In some such implementations, to support updating the angle of transmission for the set of antennas, the antenna update component 1030 is configurable or configured to decrease the angle of transmission for the set of antennas in accordance with the update to the antenna configuration parameter, where the connection with the UE is removed in accordance with the decreased angle of transmission.

In some other implementations, the network entity is within a threshold distance from the geographic area of the wireless network. In some such implementations, the UE connection component 1040 is configurable or configured to establish a connection with a UE located within the geographic area of the wireless network in accordance with the updated angle of transmission for the set of antennas. In some such implementations, to support updating the angle of transmission for the set of antennas, the antenna update component 1030 is configurable or configured to increase the angle of transmission for the set of antennas in accordance with the update to the antenna configuration parameter, where the connection with the UE is established in accordance with the increased angle of transmission.

In some implementations, the command further indicates a second update to a second antenna configuration parameter for a second network entity of the wireless network. In some such implementations, the UE connection component 1040 is configurable or configured to establish a connection with a UE located within a second geographic area of the wireless network that is affected by the second update to the second antenna configuration parameter for the second network entity.

In some implementations, the antenna update component 1030 is configurable or configured to update a transmit power, an antenna profile, an antenna azimuth, an antenna port configuration, or any combination thereof for the set of antennas in accordance with the update to the antenna configuration parameter. In some implementations, the threshold value corresponds to the wireless network, a service provided by the wireless network, or both.

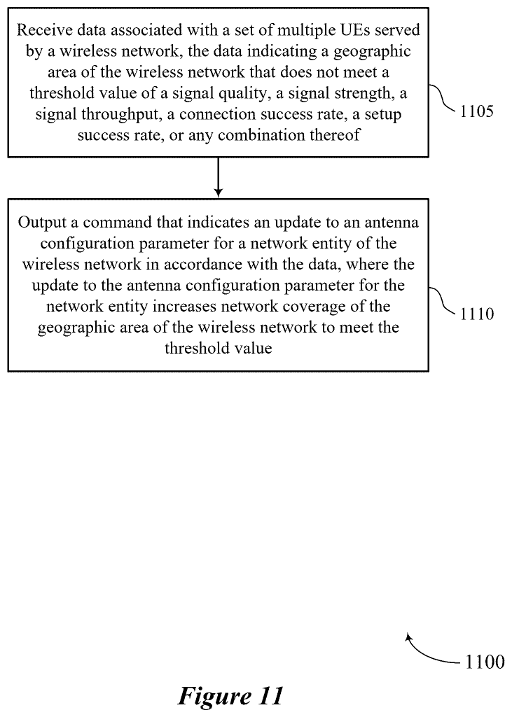

FIG. 11 shows a flowchart illustrating an example method 1100 that supports resolving network weak spots according to UE data. The operations of the method 1100 may be implemented by a device or its components as described herein. For example, the operations of the method 1100 may be performed by a device 605 or a device 920 as described with reference to FIGS. 6 and 9. In some implementations, a device may execute a set of instructions to control the functional elements of the device to perform the described functions. Additionally, or alternatively, the device may perform aspects of the described functions using special-purpose hardware.

At 1105, the method may include receiving data associated with a set of multiple UEs served by a wireless network, the data indicating a geographic area of the wireless network that does not meet a threshold value of a signal quality, a signal strength, a signal throughput, a connection success rate, a setup success rate, or any combination thereof. The operations of 1105 may be performed in accordance with examples as disclosed herein. In some implementations, aspects of the operations of 1105 may be performed by a UE data aggregation component 925 as described with reference to FIG. 9.

At 1110, the method may include outputting a command that indicates an update to an antenna configuration parameter for a network entity of the wireless network in accordance with the data, where the update to the antenna configuration parameter for the network entity increases network coverage of the geographic area of the wireless network to meet the threshold value. The operations of 1110 may be performed in accordance with examples as disclosed herein. In some implementations, aspects of the operations of 1110 may be performed by a network update component 930 as described with reference to FIG. 9.

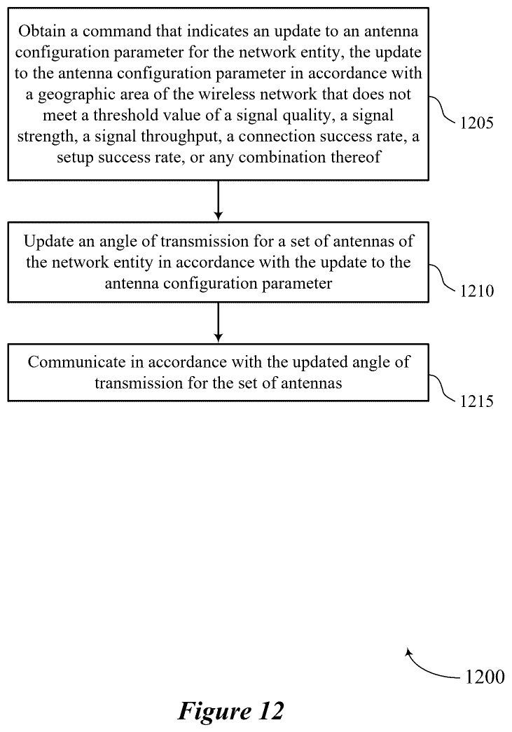

FIG. 12 shows a flowchart illustrating an example method 1200 that supports resolving network weak spots according to UE data. The operations of the method 1200 may be implemented by a network entity or its components as described herein. For example, the operations of the method 1200 may be performed by a network entity 105 as described with reference to FIGS. 1-6 and 10. In some implementations, a network entity may execute a set of instructions to control the functional elements of the network entity to perform the described functions. Additionally, or alternatively, the network entity may perform aspects of the described functions using special-purpose hardware.

At 1205, the method may include obtaining a command that indicates an update to an antenna configuration parameter for the network entity, the update to the antenna configuration parameter in accordance with a geographic area of the wireless network that does not meet a threshold value of a signal quality, a signal strength, a signal throughput, a connection success rate, a setup success rate, or any combination thereof. The operations of 1205 may be performed in accordance with examples as disclosed herein. In some implementations, aspects of the operations of 1205 may be performed by an update request component 1025 as described with reference to FIG. 10.

At 1210, the method may include updating an angle of transmission for a set of antennas of the network entity in accordance with the update to the antenna configuration parameter. The operations of 1210 may be performed in accordance with examples as disclosed herein. In some implementations, aspects of the operations of 1210 may be performed by an antenna update component 1030 as described with reference to FIG. 10.

At 1215, the method may include communicating in accordance with the updated angle of transmission for the set of antennas. The operations of 1215 may be performed in accordance with examples as disclosed herein. In some implementations, aspects of the operations of 1215 may be performed by a communication component 1035 as described with reference to FIG. 10.

Implementation examples are described in the following numbered clauses:

Aspect 1: A device, including: a processing system that includes processor circuitry and memory circuitry that stores code, the processing system configured to cause the device to: receive data associated with a set of multiple UEs served by a wireless network, the data indicating a geographic area of the wireless network that does not meet a threshold value of a signal quality, a signal strength, a signal throughput, a connection success rate, a setup success rate, or any combination thereof; and output a command that indicates an update to an antenna configuration parameter for a network entity of the wireless network in accordance with the data, where the update to the antenna configuration parameter for the network entity increases network coverage of the geographic area of the wireless network to meet the threshold value.

Aspect 2: The device of aspect 1, where the processing system is further configured to cause the device to: select the update to the antenna configuration parameter for the network entity in accordance with a multi-dimensional signal strength map for the wireless network, the data associated with the set of multiple UEs providing information that defines the multi-dimensional signal strength map.

Aspect 3: The device of either of aspects 1 or 2, where the processing system is further configured to cause the device to: select a set of multiple impacted tiles, a set of multiple impacted cells, or both in accordance with the network entity being a service provider or an interferer for each impacted tile of the set of multiple impacted tiles, each impacted cell of the set of multiple impacted cells, or both, where an updated measurement of the signal quality, the signal strength, the signal throughput, the connection success rate, the setup success rate, or any combination thereof is calculated for the set of multiple impacted tiles, the set of multiple impacted cells, or both in accordance with the update to the antenna configuration parameter for the network entity.

Aspect 4: The device of aspect 3, where the data associated with the set of multiple UEs further indicates a quantity of UEs, a volume of traffic, or both for the set of multiple impacted tiles, the set of multiple impacted cells, or both; and the updated measurement is weighted in accordance with the quantity of UEs, the volume of traffic, or both for the set of multiple impacted tiles, the set of multiple impacted cells, or both.

Aspect 5: The device of any of aspects 1-4, where the processing system is further configured to cause the device to: select a set of multiple updates to a set of multiple antenna configuration parameters for a set of multiple network entities of the wireless network in accordance with an AI model, where the set of multiple updates to the set of multiple antenna configuration parameters includes the update to the antenna configuration parameter.

Aspect 6: The device of aspect 5, where, to output the command, the processing system is configured to cause the device to: output the command in accordance with the geographic area of the wireless network meeting the threshold value, an improvement to the signal quality, the signal strength, the signal throughput, the connection success rate, the setup success rate, or any combination thereof for the wireless network, an absence of additional geographic areas of the wireless network not meeting the threshold value, or any combination thereof according to the set of multiple updates to the set of multiple antenna configuration parameters for the set of multiple network entities.

Aspect 7: The device of any of aspects 1-6, where the geographic area of the wireless network does not meet the threshold value in accordance with: a quantity of RLFs associated with the geographic area being greater than a threshold quantity of RLFs, a quantity of RACH failures associated with the geographic area being greater than a threshold quantity of RACH failures, one or more RSRP measurements associated with the geographic area being less than a threshold RSRP value, one or more throughput measurements associated with the geographic area being less than a threshold throughput value, or any combination thereof.

Aspect 8: The device of any of aspects 1-7, where the network entity is outside a threshold distance from the geographic area of the wireless network; and the update to the antenna configuration parameter for the network entity decreases coverage by the network entity of at least a portion of the geographic area of the wireless network.

Aspect 9: The device of aspect 8, where the update to the antenna configuration parameter for the network entity includes a decrease to an angle of transmission for a set of antennas of the network entity.

Aspect 10: The device of any of aspects 1-7, where the network entity is within a threshold distance from the geographic area of the wireless network; and the update to the antenna configuration parameter for the network entity increases coverage by the network entity of at least a portion of the geographic area of the wireless network.

Aspect 11: The device of aspect 10, where the update to the antenna configuration parameter for the network entity includes an increase to an angle of transmission for a set of antennas of the network entity.

Aspect 12: The device of any of aspects 1-11, where the command further indicates a second update to a second antenna configuration parameter for a second network entity of the wireless network in accordance with the update to the antenna configuration parameter for the network entity.

Aspect 13: The device of any of aspects 1-12, where the antenna configuration parameter includes an angle of transmission, a transmit power, an antenna profile, an antenna azimuth, an antenna port configuration, or any combination thereof.

Aspect 14: The device of any of aspects 1-13, where the threshold value corresponds to the wireless network, a service provided by the wireless network, or both.

Aspect 15: A network entity of a wireless network, including: a processing system that includes processor circuitry and memory circuitry that stores code, the processing system configured to cause the network entity to: obtain a command that indicates an update to an antenna configuration parameter for the network entity, the update to the antenna configuration parameter in accordance with a geographic area of the wireless network that does not meet a threshold value of a signal quality, a signal strength, a signal throughput, a connection success rate, a setup success rate, or any combination thereof; update an angle of transmission for a set of antennas of the network entity in accordance with the update to the antenna configuration parameter; and communicate in accordance with the updated angle of transmission for the set of antennas.

Aspect 16: The network entity of aspect 15, where the processing system is further configured to cause the network entity to: update a physical antenna configuration, an antenna port configuration, or both for the set of antennas in accordance with the update to the antenna configuration parameter.

Aspect 17: The network entity of either of aspects 15 or 16, where the network entity is outside a threshold distance from the geographic area of the wireless network; and to communicate, the processing system is configured to cause the network entity to: remove a connection with a UE located within the geographic area of the wireless network in accordance with the updated angle of transmission for the set of antennas.

Aspect 18: The network entity of aspect 17, where, to update the angle of transmission for the set of antennas, the processing system is configured to cause the network entity to: decrease the angle of transmission for the set of antennas in accordance with the update to the antenna configuration parameter, where the connection with the UE is removed in accordance with the decreased angle of transmission.

Aspect 19: The network entity of either of aspects 15 or 16, where the network entity is within a threshold distance from the geographic area of the wireless network; and to communicate, the processing system is configured to cause the network entity to: establish a connection with a UE located within the geographic area of the wireless network in accordance with the updated angle of transmission for the set of antennas.

Aspect 20: The network entity of aspect 19, where, to update the angle of transmission for the set of antennas, the processing system is configured to cause the network entity to: increase the angle of transmission for the set of antennas in accordance with the update to the antenna configuration parameter, where the connection with the UE is established in accordance with the increased angle of transmission.

Aspect 21: The network entity of any of aspects 15-20, where the command further indicates a second update to a second antenna configuration parameter for a second network entity of the wireless network; and to communicate, the processing system is configured to cause the network entity to: establish a connection with a UE located within a second geographic area of the wireless network that is affected by the second update to the second antenna configuration parameter for the second network entity.

Aspect 22: The network entity of any of aspects 15-21, where the processing system is further configured to cause the network entity to: update a transmit power, an antenna profile, an antenna azimuth, an antenna port configuration, or any combination thereof for the set of antennas in accordance with the update to the antenna configuration parameter.

Aspect 23: The network entity of any of aspects 15-22, where the threshold value corresponds to the wireless network, a service provided by the wireless network, or both.

Aspect 24: A method for wireless communications, including: receiving data associated with a set of multiple UEs served by a wireless network, the data indicating a geographic area of the wireless network that does not meet a threshold value of a signal quality, a signal strength, a signal throughput, a connection success rate, a setup success rate, or any combination thereof; and outputting a command that indicates an update to an antenna configuration parameter for a network entity of the wireless network in accordance with the data, where the update to the antenna configuration parameter for the network entity increases network coverage of the geographic area of the wireless network to meet the threshold value.

Aspect 25: The method of aspect 24, further including: selecting the update to the antenna configuration parameter for the network entity in accordance with a multi-dimensional signal strength map for the wireless network, the data associated with the set of multiple UEs providing information that defines the multi-dimensional signal strength map.

Aspect 26: The method of either of aspects 24 or 25, further including: selecting a set of multiple impacted tiles, a set of multiple impacted cells, or both in accordance with the network entity being a service provider or an interferer for each impacted tile of the set of multiple impacted tiles, each impacted cell of the set of multiple impacted cells, or both, where an updated measurement of the signal quality, the signal strength, the signal throughput, the connection success rate, the setup success rate, or any combination thereof is calculated for the set of multiple impacted tiles, the set of multiple impacted cells, or both in accordance with the update to the antenna configuration parameter for the network entity.

Aspect 27: The method of aspect 26, where the data associated with the set of multiple UEs further indicates a quantity of UEs, a volume of traffic, or both for the set of multiple impacted tiles, the set of multiple impacted cells, or both; and the updated measurement is weighted in accordance with the quantity of UEs, the volume of traffic, or both for the set of multiple impacted tiles, the set of multiple impacted cells, or both.

Aspect 28: The method of any of aspects 24-27, further including: selecting a set of multiple updates to a set of multiple antenna configuration parameters for a set of multiple network entities of the wireless network in accordance with an AI model, where the set of multiple updates to the set of multiple antenna configuration parameters includes the update to the antenna configuration parameter.

Aspect 29: The method of aspect 28, where outputting the command includes: outputting the command in accordance with the geographic area of the wireless network meeting the threshold value, an improvement to the signal quality, the signal strength, the signal throughput, the connection success rate, the setup success rate, or any combination thereof for the wireless network, an absence of additional geographic areas of the wireless network not meeting the threshold value, or any combination thereof according to the set of multiple updates to the set of multiple antenna configuration parameters for the set of multiple network entities.

Aspect 30: The method of any of aspects 24-29, where the geographic area of the wireless network does not meet the threshold value in accordance with: a quantity of RLFs associated with the geographic area being greater than a threshold quantity of RLFs, a quantity of RACH failures associated with the geographic area being greater than a threshold quantity of RACH failures, one or more RSRP measurements associated with the geographic area being less than a threshold RSRP value, one or more throughput measurements associated with the geographic area being less than a threshold throughput value, or any combination thereof.

Aspect 31: The method of any of aspects 24-30, where the network entity is outside a threshold distance from the geographic area of the wireless network; and the update to the antenna configuration parameter for the network entity decreases coverage by the network entity of at least a portion of the geographic area of the wireless network.

Aspect 32: The method of aspect 31, where the update to the antenna configuration parameter for the network entity includes a decrease to an angle of transmission for a set of antennas of the network entity.

Aspect 33: The method of any of aspects 24-30, where the network entity is within a threshold distance from the geographic area of the wireless network; and the update to the antenna configuration parameter for the network entity increases coverage by the network entity of at least a portion of the geographic area of the wireless network.

Aspect 34: The method of aspect 33, where the update to the antenna configuration parameter for the network entity includes an increase to an angle of transmission for a set of antennas of the network entity.

Aspect 35: The method of any of aspects 24-34, where the command further indicates a second update to a second antenna configuration parameter for a second network entity of the wireless network in accordance with the update to the antenna configuration parameter for the network entity.

Aspect 36: The method of any of aspects 24-35, where the antenna configuration parameter includes an angle of transmission, a transmit power, an antenna profile, an antenna azimuth, an antenna port configuration, or any combination thereof.

Aspect 37: The method of any of aspects 24-36, where the threshold value corresponds to the wireless network, a service provided by the wireless network, or both.

Aspect 38: A method for wireless communications at a network entity of a wireless network, including: obtaining a command that indicates an update to an antenna configuration parameter for the network entity, the update to the antenna configuration parameter in accordance with a geographic area of the wireless network that does not meet a threshold value of a signal quality, a signal strength, a signal throughput, a connection success rate, a setup success rate, or any combination thereof; updating an angle of transmission for a set of antennas of the network entity in accordance with the update to the antenna configuration parameter; and communicating in accordance with the updated angle of transmission for the set of antennas.

Aspect 39: The method of aspect 38, further including: updating a physical antenna configuration, an antenna port configuration, or both for the set of antennas in accordance with the update to the antenna configuration parameter.

Aspect 40: The method of either of aspects 38 or 39, where the network entity is outside a threshold distance from the geographic area of the wireless network; and the communicating includes: removing a connection with a UE located within the geographic area of the wireless network in accordance with the updated angle of transmission for the set of antennas.

Aspect 41: The method of aspect 40, where updating the angle of transmission for the set of antennas includes: decreasing the angle of transmission for the set of antennas in accordance with the update to the antenna configuration parameter, where the connection with the UE is removed in accordance with the decreased angle of transmission.

Aspect 42: The method of either of aspects 38 or 39, where the network entity is within a threshold distance from the geographic area of the wireless network; and the communicating includes: establishing a connection with a UE located within the geographic area of the wireless network in accordance with the updated angle of transmission for the set of antennas.

Aspect 43: The method of aspect 42, where updating the angle of transmission for the set of antennas includes: increasing the angle of transmission for the set of antennas in accordance with the update to the antenna configuration parameter, where the connection with the UE is established in accordance with the increased angle of transmission.

Aspect 44: The method of any of aspects 38-43, where the command further indicates a second update to a second antenna configuration parameter for a second network entity of the wireless network; and the communicating includes: establishing a connection with a UE located within a second geographic area of the wireless network that is affected by the second update to the second antenna configuration parameter for the second network entity.

Aspect 45: The method of any of aspects 38-44, further including: updating a transmit power, an antenna profile, an antenna azimuth, an antenna port configuration, or any combination thereof for the set of antennas in accordance with the update to the antenna configuration parameter.

Aspect 46: The method of any of aspects 38-45, where the threshold value corresponds to the wireless network, a service provided by the wireless network, or both.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), or accessing (such as accessing data stored in memory), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A device, comprising:
a processing system that includes processor circuitry and memory circuitry that stores code, the processing system configured to cause the device to:
receive data associated with a plurality of user equipment (UEs) served by a wireless network, the data indicating a geographic area of the wireless network that does not meet a threshold value of a signal quality, a signal strength, a signal throughput, a connection success rate, a setup success rate, or any combination thereof; and
output a command that indicates an update to an antenna configuration parameter for a network entity of the wireless network in accordance with the data, wherein the update to the antenna configuration parameter for the network entity increases network coverage of the geographic area of the wireless network to meet the threshold value.

2. The device of claim 1, wherein the processing system is further configured to cause the device to:
select the update to the antenna configuration parameter for the network entity in accordance with a multi-dimensional signal strength map for the wireless network, the data associated with the plurality of UEs providing information that defines the multi-dimensional signal strength map.

3. The device of claim 1, wherein the processing system is further configured to cause the device to:
select a plurality of impacted tiles, a plurality of impacted cells, or both in accordance with the network entity being a service provider or an interferer for each impacted tile of the plurality of impacted tiles, each impacted cell of the plurality of impacted cells, or both, wherein an updated measurement of the signal quality, the signal strength, the signal throughput, the connection success rate, the setup success rate, or any combination thereof is calculated for the plurality of impacted tiles, the plurality of impacted cells, or both in accordance with the update to the antenna configuration parameter for the network entity.

4. The device of claim 3, wherein:
the data associated with the plurality of UEs further indicates a quantity of UEs, a volume of traffic, or both for the plurality of impacted tiles, the plurality of impacted cells, or both; and
the updated measurement is weighted in accordance with the quantity of UEs, the volume of traffic, or both for the plurality of impacted tiles, the plurality of impacted cells, or both.

5. The device of claim 1, wherein the processing system is further configured to cause the device to:
select a plurality of updates to a plurality of antenna configuration parameters for a plurality of network entities of the wireless network in accordance with an artificial intelligence (AI) model, wherein the plurality of updates to the plurality of antenna configuration parameters comprises the update to the antenna configuration parameter.

6. The device of claim 5, wherein, to output the command, the processing system is configured to cause the device to:
output the command in accordance with the geographic area of the wireless network meeting the threshold value, an improvement to the signal quality, the signal strength, the signal throughput, the connection success rate, the setup success rate, or any combination thereof for the wireless network, an absence of additional geographic areas of the wireless network not meeting the threshold value, or any combination thereof according to the plurality of updates to the plurality of antenna configuration parameters for the plurality of network entities.

7. The device of claim 1, wherein the geographic area of the wireless network does not meet the threshold value in accordance with:
a quantity of radio link failures associated with the geographic area being greater than a threshold quantity of radio link failures,
a quantity of random access channel (RACH) failures associated with the geographic area being greater than a threshold quantity of RACH failures,
one or more reference signal received power (RSRP) measurements associated with the geographic area being less than a threshold RSRP value,
one or more throughput measurements associated with the geographic area being less than a threshold throughput value, or
any combination thereof.

8. The device of claim 1, wherein:
the network entity is outside a threshold distance from the geographic area of the wireless network; and
the update to the antenna configuration parameter for the network entity decreases coverage by the network entity of at least a portion of the geographic area of the wireless network.

9. The device of claim 1, wherein:
the network entity is within a threshold distance from the geographic area of the wireless network; and
the update to the antenna configuration parameter for the network entity increases coverage by the network entity of at least a portion of the geographic area of the wireless network.

10. The device of claim 1, wherein the antenna configuration parameter comprises an angle of transmission, a transmit power, an antenna profile, an antenna azimuth, an antenna port configuration, or any combination thereof.

11. The device of claim 1, wherein the command further indicates a second update to an additional parameter that affects a coverage area for which the network entity provides active coverage.

12. The device of claim 11, wherein the additional parameter is associated with an A5 measurement event, a B1 measurement event, a B2 measurement event, or any combination thereof.

13. A network entity of a wireless network, comprising:
a processing system that includes processor circuitry and memory circuitry that stores code, the processing system configured to cause the network entity to:
obtain a command that indicates an update to an antenna configuration parameter for the network entity, the update to the antenna configuration parameter in accordance with a geographic area of the wireless network that does not meet a threshold value of a signal quality, a signal strength, a signal throughput, a connection success rate, a setup success rate, or any combination thereof;
update an angle of transmission for a set of antennas of the network entity in accordance with the update to the antenna configuration parameter; and
communicate in accordance with the updated angle of transmission for the set of antennas.

14. The network entity of claim 13, wherein the processing system is further configured to cause the network entity to:
update a physical antenna configuration, an antenna port configuration, or both for the set of antennas in accordance with the update to the antenna configuration parameter.

15. The network entity of claim 13, wherein:
the network entity is outside a threshold distance from the geographic area of the wireless network; and
to communicate, the processing system is configured to cause the network entity to:
remove a connection with a UE located within the geographic area of the wireless network in accordance with the updated angle of transmission for the set of antennas.

16. The network entity of claim 15, wherein, to update the angle of transmission for the set of antennas, the processing system is configured to cause the network entity to:
decrease the angle of transmission for the set of antennas in accordance with the update to the antenna configuration parameter, wherein the connection with the UE is removed in accordance with the decreased angle of transmission.

17. The network entity of claim 13, wherein:
the network entity is within a threshold distance from the geographic area of the wireless network; and
to communicate, the processing system is configured to cause the network entity to:
establish a connection with a UE located within the geographic area of the wireless network in accordance with the updated angle of transmission for the set of antennas.

18. The network entity of claim 17, wherein, to update the angle of transmission for the set of antennas, the processing system is configured to cause the network entity to:
increase the angle of transmission for the set of antennas in accordance with the update to the antenna configuration parameter, wherein the connection with the UE is established in accordance with the increased angle of transmission.

19. The network entity of claim 13, wherein the processing system is further configured to cause the network entity to:
update a transmit power, an antenna profile, an antenna azimuth, an antenna port configuration, or any combination thereof for the set of antennas in accordance with the update to the antenna configuration parameter.

20. A method for wireless communications, comprising:
receiving data associated with a plurality of user equipment (UEs) served by a wireless network, the data indicating a geographic area of the wireless network that does not meet a threshold value of a signal quality, a signal strength, a signal throughput, a connection success rate, a setup success rate, or any combination thereof; and
outputting a command that indicates an update to an antenna configuration parameter for a network entity of the wireless network in accordance with the data, wherein the update to the antenna configuration parameter for the network entity increases network coverage of the geographic area of the wireless network to meet the threshold value.
